(19) United States
(12) Patent Application Publication
(10) Pub. No.: US 2007/0237074 A1
(43) Pub. Date: Oct. 11, 2007

(54) Configuration of congestion thresholds for a network traffic management system

(76) Inventor: David S. Curry, San Jose, CA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/399,301

(22) Filed: Apr. 6, 2006

(51) Int. Cl. H04L 12/26

(52) U.S. Cl. 370/229

(57) ABSTRACT

A hierarchical congestion management system improves the performance of traffic through a communications system. In one embodiment of the invention, a first subset of thresholds is configured so as to guarantee the passage of a certain high-priority or other selected communications traffic. Further, a second subset of thresholds is configured to control interference among independent flows of traffic that are competing to pass through the system. As a result of these configurations, traffic flows that cause congestion at the output are isolated to prevent dropping other traffic, and high-priority traffic is ensured passage.

### RELATED APPLICATIONS

This application claims the benefit of U.S. Provisional Applications with attorney docket number 2376.2077-000, filed on Mar. 28, 2006, and attorney docket number 2376.2077-001, filed on Mar. 30, 2006, both entitled “Configuration of Congestion Thresholds.” The entire teachings of the above applications are incorporated herein by reference.

### BACKGROUND OF THE INVENTION

As the Internet evolves into a worldwide commercial data network for electronic commerce and managed public data services, increasingly, customer demands have focused on the need for advanced Internet Protocol (IP) services to enhance content hosting, broadcast video and application outsourcing. To remain competitive, network operators and Internet service providers (ISPs) must resolve two main issues: meeting continually increasing backbone traffic demands and providing a suitable Quality of Service (QoS) for that traffic. Currently, many ISPs have implemented various virtual path techniques to meet the new challenges. Generally, the existing virtual path techniques require a collection of physical overlay networks and equipment. The most common existing virtual path techniques are: optical transport, asynchronous transfer mode (ATM)/frame relay (FR) switched layer, and narrowband internet protocol virtual private networks (IP VPN).

The optical transport technique is the most widely used virtual path technique. Under this technique, an ISP uses point-to-point broadband bit pipes to custom design a point-to-point circuit or network per customer. Thus, this technique requires the ISP to create a new circuit or network whenever a new customer is added. Once a circuit or network for a customer is created, the available bandwidth for that circuit or network remains static.

The ATM/FR switched layer technique provides QoS and traffic engineering via point-to-point virtual circuits. Thus, this technique does not require creations of dedicated physical circuits or networks compared to the optical transport technique. Although this technique is an improvement over the optical transport technique, this technique has several drawbacks. One major drawback of the ATM/FR technique is that this type of network is not scalable. In addition, the ATM/FR technique also requires that a virtual circuit be established every time a request to send data is received from a customer.

The narrowband IP VPN technique uses best effort delivery and encrypted tunnels to provide secured paths to the customers. One major drawback of a best effort delivery is the lack of guarantees that a packet will be delivered at all. Thus, this is not a good candidate when transmitting critical data.

A data communications network often includes one or more routers that control flow of communications traffic between remote nodes. Such routers control flow of ingress traffic to a local node, as well as flow of egress traffic delivered from the local node to a remote node.

Thus, it may be of interest to provide apparatus and methods that reduce operating costs for service providers by collapsing multiple overlay networks into a multi-service IP backbone. In particular, it may be of interest to provide apparatus and methods that allow an ISP to build the network once and sell such network multiple times to multiple customers.

In addition, data packets coming across a network may be encapsulated in different protocol headers or have nested or stacked protocols. Examples of existing protocols are: IP, ATM, FR, multi-protocol label switching (MPLS), and Ethernet. Thus, it may be of further interest to provide apparatus that are programmable to accommodate existing protocols and to anticipate any future protocols. It may be of further interest to provide apparatus and methods that efficiently schedules packets in a broadband data stream.

### SUMMARY OF THE INVENTION

Example embodiments of the present invention provide a method of configuring a hierarchical congestion manager to improve performance of traffic flow through a traffic management system, such as a router, in a communications network. In one embodiment, a first subset of thresholds is configured to guarantee passage of certain high-priority or other selected communications traffic through a router in the communications network. Further, a second subset of thresholds is configured to control interference among independent flows of traffic that are competing to pass through the router in the communications network. As a result of these configurations, traffic flows that cause congestion at the output are isolated to prevent dropping other traffic, and high-priority traffic is ensured passage through the traffic management system in the communications network.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating the example embodiments of the invention.

FIG. 1 schematically illustrates an exemplary traffic management system in accordance with an embodiment of the invention.

FIG. 2 schematically illustrates an exemplary packet scheduler in accordance with an embodiment of the invention.

FIG. 3 illustrates an exemplary policing process in accordance with an embodiment of the invention.

FIG. 4 illustrates an exemplary congestion management process in accordance with an embodiment of the invention.

FIG. 5 illustrates an exemplary representation of the congestion management process of FIG. 4.

FIG. 6 illustrates another exemplary congestion management process in accordance with an embodiment of the invention.

FIG. 7 illustrates an exemplary scheduler in accordance with an embodiment of the invention.

FIGS. 8A-8C illustrate exemplary connection states in accordance with an embodiment of the invention.

FIG. 9 illustrates an exemplary virtual output queue handler in accordance with an embodiment of the invention.

FIG. 10 illustrates another exemplary virtual output queue handler in accordance with an embodiment of the invention.

FIG. 11 illustrates an example hierarchy of communication flows, organized by multiple convergence points and subject to multiple congestion thresholds in an example traffic management system, according to the present invention.

FIG. 12 is a flow diagram of the MRED process of FIG. 4, expanded for operation with multiple different congestion thresholds.

FIG. 13A is a table of congestion thresholds.

FIG. 13B is a graph depicting the congestion thresholds of FIG. 13A.

FIGS. 14A-D illustrate four exemplary threshold configurations.

FIGS. 15A-C illustrate an exemplary threshold configuration across packets of different flows and groups.

### DETAILED DESCRIPTION OF THE INVENTION

A description of example embodiments of the invention follows.

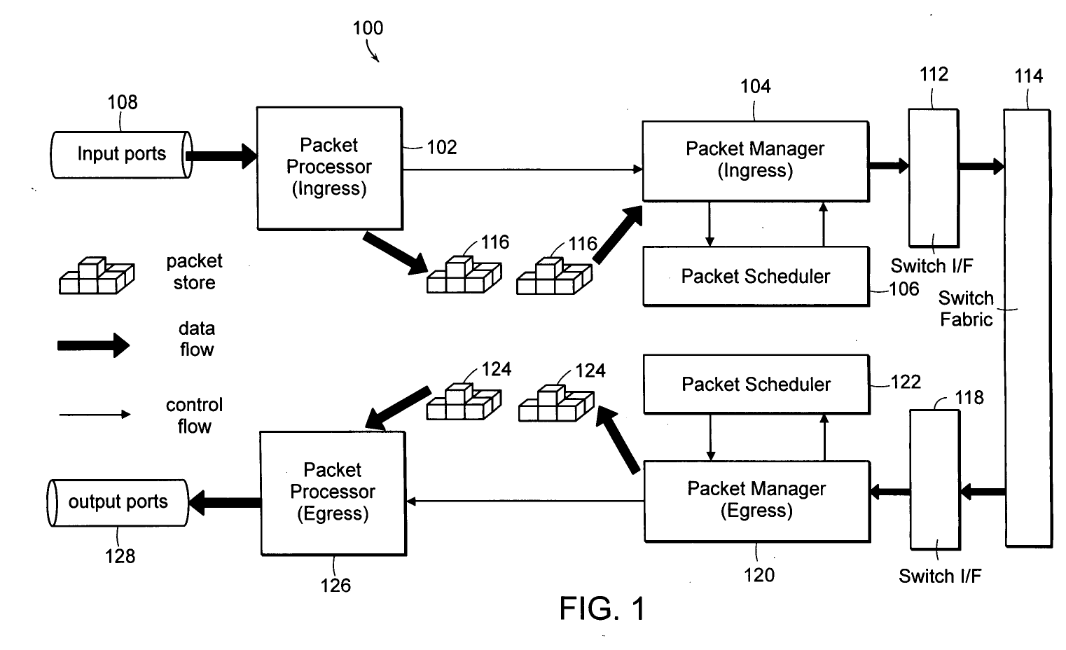

FIG. 1 schematically illustrates a traffic management system 100 for managing packet traffic in a network. In the ingress direction, the traffic management system 100 comprises a packet processor 102, a packet manager 104, a packet scheduler 106, a switch interface 112, and a switch fabric 114. The packet processor 102 receives packets from physical input ports 108 in the ingress direction.

In the ingress direction, the packet processor 102 receives incoming packets managed by the packet manager 104. After a packet is stored in the buffer 116, a copy of a packet descriptor, which includes a packet identifier and other packet information, is sent from the packet manager 104 to the packet scheduler 106 to be processed for traffic control. The packet scheduler 106 performs policing and congestion management processes on any received packet identifier. The packet scheduler 106 sends instructions to the packet manager 104 to either drop a packet, due to policing or congestion, or send a packet according to a schedule. Typically, the packet scheduler 106 determines such a schedule for each packet. If a packet is to be sent, the packet identifier of that packet is shaped and queued by the packet scheduler 106. The packet scheduler 106 then sends the modified packet identifier to the packet manager 104. Upon receipt of a modified packet identifier, the packet manager 104 transmits the packet identified by the packet identifier to the switch interface 112 during the designated time slot to be sent out via the switch fabric 114.

In the egress direction, packets arrive through the switch fabric 114 and switch interface 118, and go through similar processes in a packet manager 120, a packet scheduler 122, a buffer 124, and a packet processor 126. Finally, egress packets exit the system through output ports 128. Operational differences between ingress and egress are configurable.

The packet processor 102 and the packet manager 104 are described in more detail in related applications as referenced above.

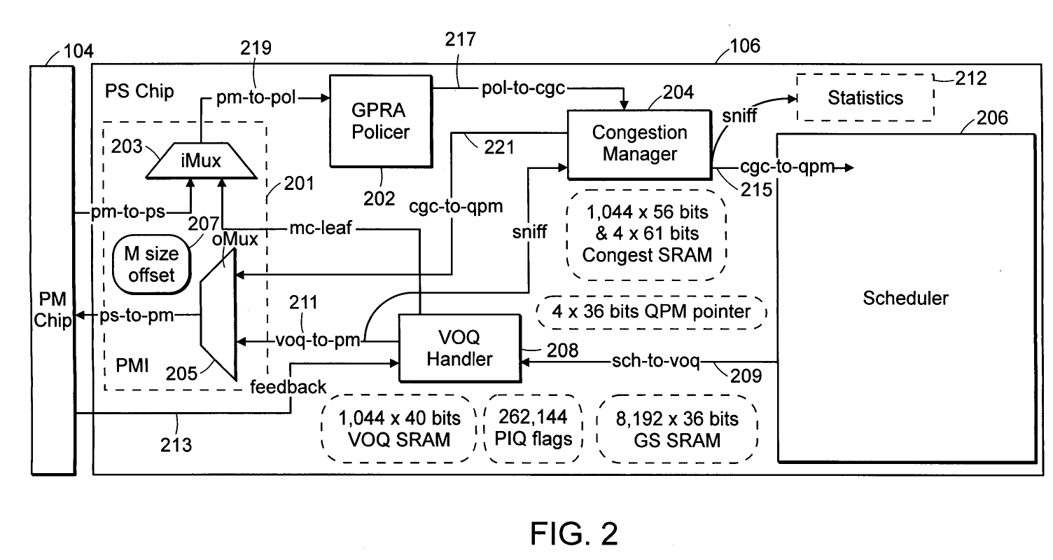

FIG. 2 illustrates an exemplary packet scheduler 106. The packet scheduler 106 includes a packet manager interface 201, a policer 202, a congestion manager 204, a scheduler 206, and a virtual output queue (VOQ) handler 208. The packet manager interface 201 includes an input multiplexer 203, an output multiplexer 205, and a global packet size offset register 207. In an exemplary embodiment, when the packet manager 104 receives a data packet, it sends a packet descriptor to the packet manager interface 201. In an exemplary embodiment, the packet descriptor includes a packet identifier (PID), an input connection identifier (ICID), packet size information, and a header. The packet manager interface 201 subtracts the header from the packet descriptor before sending the remaining packet descriptor to the policer 202 via a signal line 219. The actual packet size of the packet is stored in the global packet size offset register 207. In general, the packet descriptor is processed by the policer 202, the congestion manager 204, the scheduler 206, and the virtual output queue handler 208, in turn, then outputted to the packet manager 104 through the packet manager interface 201. In an exemplary embodiment, the header, which was subtracted earlier before the packet descriptor was sent to the policer 202, is added back to the packet descriptor in the packet manager interface 201 before the packet descriptor is outputted to the packet manager 104.

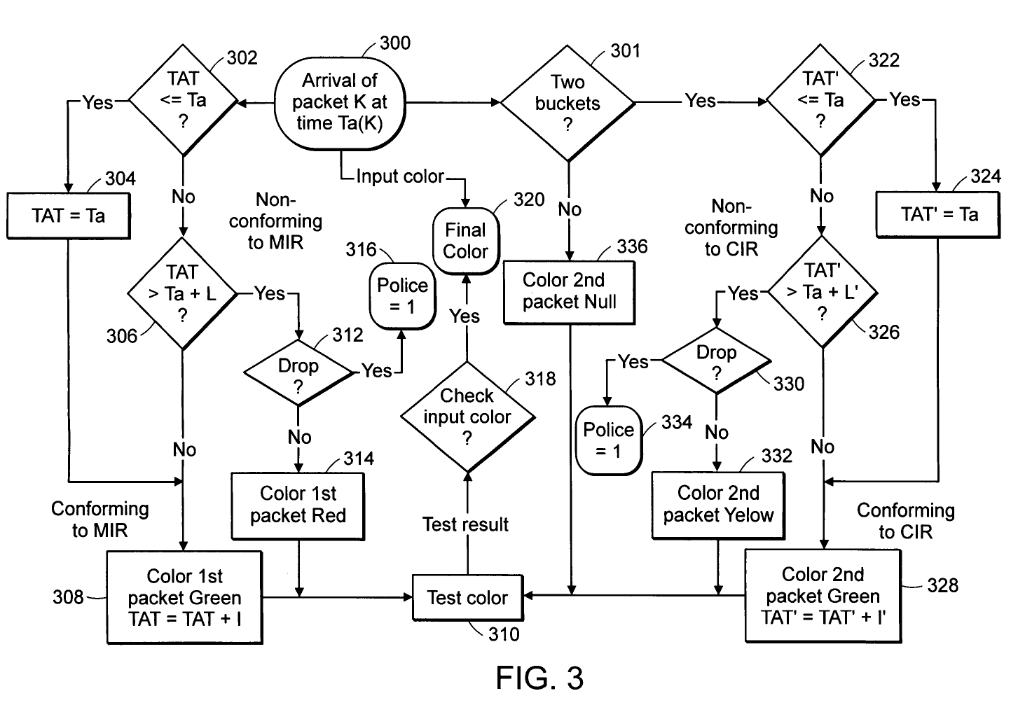

The policer 202 performs a policing process on received packet descriptors. In an exemplary embodiment, the policing process is configured to handle variably-sized packets. In one embodiment, the policer 202 supports a set of virtual connections identified by the ICIDs included in the packet descriptors. Typically, the policer 202 stores configuration parameters for those virtual connections in an internal memory indexed by the ICIDs. Output signals from the policer 202 include a color code for each packet descriptor. In an exemplary embodiment, the color code identifies a packet's compliance to its assigned priority. The packet descriptors and their respective color codes are sent by the policer 202 to the congestion manager 204 via a signal line 217. An exemplary policing process performed by the policer 202 is provided in FIG. 3, which is discussed below.

Depending on congestion levels, the congestion manager 204 determines whether to send the packet descriptor received from the policer 202 to the scheduler 206 for further processing or to drop the packets associated with the packet descriptors. For example, if the congestion manager 204 decides that a packet should not be dropped, the congestion manager 204 sends a packet descriptor associated with that packet to the scheduler 206 to be scheduled via a signal line 215. If the congestion manager 204 decides that a packet should be dropped, the congestion manager 204 informs the packet manager 104, through the packet manager interface 201 via a signal line 221, to drop that packet.

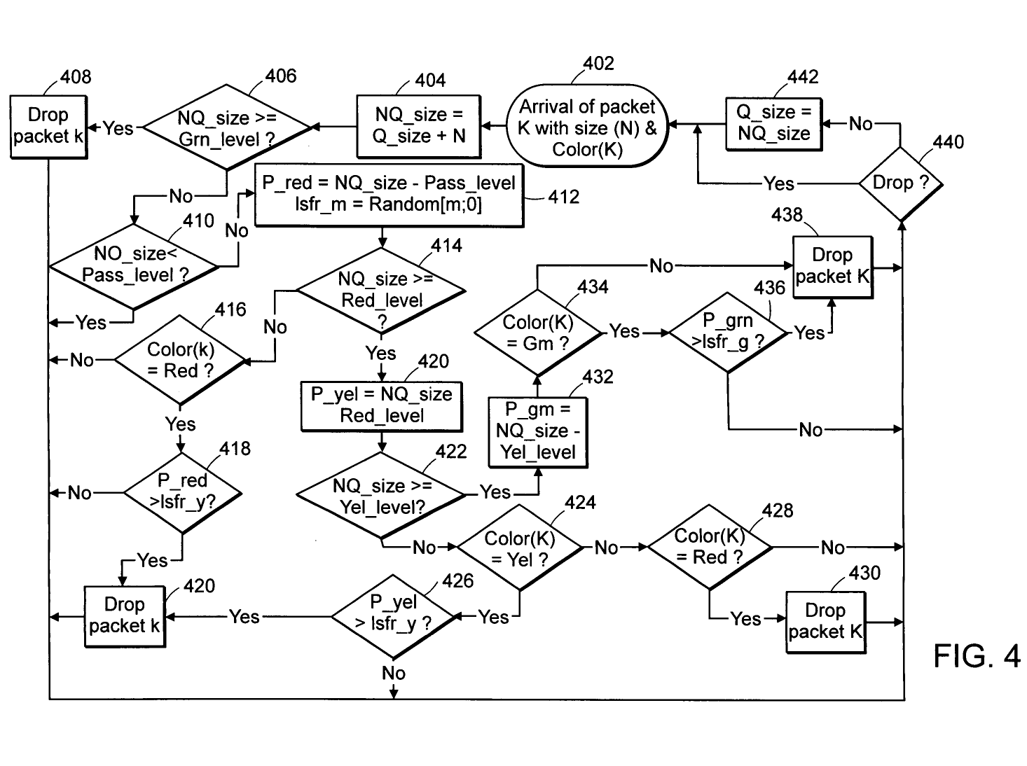

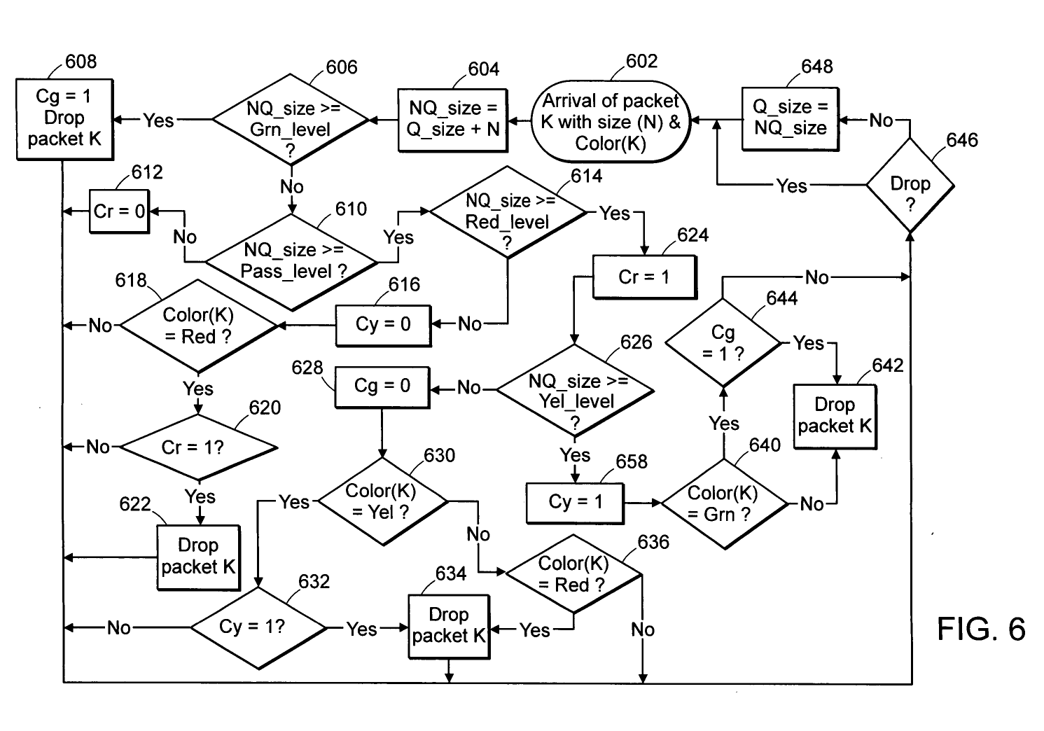

In an exemplary embodiment, the congestion manager 204 uses a congestion table to store congestion parameters for each virtual connection. In one embodiment, the congestion manager 204 also uses an internal memory to store per-port and per-priority parameters for each virtual connection. Exemplary processes performed by the congestion manager 204 are provided in FIGS. 4 and 6 below.

In an exemplary embodiment, an optional statistics block 212 in the packet scheduler 106 provides four counters per virtual connection for statistical and debugging purposes. In an exemplary embodiment, the four counters provide eight counter choices per virtual connection. In one embodiment, the statistics block 212 receives signals directly from the congestion manager 204.

The scheduler 206 schedules PIDs in accordance with configured rates for connections and group shapers. In an exemplary embodiment, the scheduler 206 links PIDs received from the congestion manager 204 to a set of input queues that are indexed by ICIDs. The scheduler 206 sends PIDs stored in the set of input queues to VOQ handler 208 via a signal line 209, beginning from the ones stored in a highest priority ICID. In an exemplary embodiment, the scheduler 206 uses internal memory to store configuration parameters per connection and parameters per group shaper. The size of the internal memory is configurable depending on the number of group shapers it supports.

In an exemplary embodiment, a scheduled PID, which is identified by a signal from the scheduler 206 to the VOQ handler 208, is queued at a virtual output queue (VOQ). The VOQ handler 208 uses a feedback signal from the packet manager 104 to select a VOQ for each scheduled packet. In one embodiment, the VOQ handler 208 sends signals to the packet manager 104 (through the packet manager interface 201 via a signal line 211) to instruct the packet manager 104 to transmit packets in a scheduled order. In an exemplary embodiment, the VOQs are allocated in an internal memory of the VOQ handler 208.

In an exemplary embodiment, if a packet to be transmitted is a multicast source packet, leaf PIDs are generated under the control of the VOQ handler 208 for the multicast source packet. The leaf PIDs are handled the same way as regular (unicast) PIDs in the policer 202, congestion manager 204, and the scheduler 206.

The Policer

There are two prior art generic cell rate algorithms, namely, the virtual schedule algorithm (VSA) and the continuous-state leaky bucket algorithm. These two algorithms essentially produce the same conforming or non-conforming result based on a sequence of packet arrival time. The policer 202 in accordance with an exemplary embodiment of this invention uses a modified VSA to perform policing compliance test. The VSA is modified to handle variable-size packets.

In an exemplary embodiment in accordance with the invention, the policer 202 performs policing processes on packets for multiple virtual connections. In an exemplary embodiment, each virtual connection is configured to utilize either one or two leaky buckets. If two leaky buckets are used, the first leaky bucket is configured to process at a user specified maximum information rate (MIR) and the second leaky bucket is configured to process at a committed information rate (CIR). If only one leaky bucket is used, the leaky bucket is configured to process at a user specified MIR. In an exemplary embodiment, each leaky bucket processes packets independently and a lower compliance result from each leaky bucket is the final result for that leaky bucket.

The first leaky bucket checks packets for compliance/conformance with the MIR and a packet delay variation tolerance (PDVT). Non-conforming packets are dropped (e.g., by setting a police bit to one) or colored red, depending upon the policing configuration. Packets that are conforming to MIR are colored green. A theoretical arrival time (TAT) calculated for the first leaky bucket is updated if a packet is conforming. The TAT is not updated if a packet is non-conforming.

The second leaky bucket, when implemented, operates substantially the same as the first leaky bucket except packets are checked for compliance/conformance to the CIR and any non-conforming packet is either dropped or colored yellow instead of red. Packets conforming to the CIR are colored green. The TAT for the second leaky bucket is updated if a packet is conforming. The TAT is not updated if a packet is non-conforming.

In an exemplary embodiment, during initial set up of a virtual circuit, a user selected policing rate is converted into a basic time interval (Tb=1/rate), based on a packet size of one byte. A floating-point format is used in the conversion so that the Tb can cover a wide range of rates (e.g., from 64 kb/s to 10 Gb/s) with acceptable granularity. The Tb, in binary representation, is stored in a policing table indexed by the ICIDs. When a packet size of N bytes is received, the policer 202 reads the Tb and a calculated TAT. In an exemplary embodiment, a TAT is calculated based on user specified policing rate for each leaky bucket. A calculated TAT is compared to a packet arrival time (Ta) to determine whether the packet conforms to the policing rate of a leaky bucket. In an exemplary embodiment, Tb and a packet size (N) are used to update the TAT if a packet is conforming. In one embodiment, for each packet that conforms to a policing rate, the TAT is updated to equal to TAT+Tb*N. Thus, the TAT may be different for each packet depending on the packet size, N.

Typically, a final result color at the end of the policing process is the final packet color. But if a “check input color” option is used, the final packet color is the lower compliance color between an input color and the final result color, where green indicates the highest compliance, yellow indicates a lower compliance than green, and red indicates the lowest compliance. In an exemplary embodiment, the policer 202 sends the final packet color and the input color to the congestion manager 204. Table 1 below lists exemplary outcomes of an embodiment of the policing process:

TABLE 1

| | | | | | FINAL COLOR | |
|---|---|---|---|---|---|---|
| Input | MIR Bucket | | CIR Bucket | | | No |
| Color | Outcome | TAT | Outcome | TAT | Check | Check |
| Green | Conform | Update | Conform | Update | Green | Green |
| Green | Conform | Update | Non- | No- | Yellow | Yellow |
| | | | Conform | update | | |
| Green | Non- | No- | Don't Care | No- | Red | Red |
| | Conform | update | | update | | |
| Yellow | Conform | Update | Conform | Update | Yellow | Green |
| Yellow | Conform | Update | Non- | No- | Yellow | Yellow |
| | | | Conform | update | | |
| Yellow | Non- | No- | Don't Care | No- | Red | Red |
| | Conform | update | | Update | | |
| Red | Conform | update | Non- | No- | Red | Green |
| | | | Conform | update | | |
| Red | Conform | Update | Conform | Update | Red | Yellow |
| Red | Non- | No- | Don't Care | No- | Red | Red |
| | Conform | update | | update | | |

FIG. 3 illustrates an exemplary policing process performed by the policer 202 in accordance with an embodiment of the invention. In FIG. 3, two leaky buckets are used. First, a process performed in the first leaky bucket is described. At step 300 a packet “k” having an input color arrives at time Ta(k). Next, the theoretical arrival time (TAT) of the first leaky bucket is compared to the arrival time (Ta) (step 302). In an exemplary embodiment, the TAT is calculated based on the MIR. If the TAT is less than or equal to Ta, the TAT is set to equal to Ta (step 304). If the TAT is greater than Ta, TAT is compared to the sum of Ta and the packet's limit, L (step 306). The limit, L, is the packet's PDVT specified during a virtual circuit set up. If the TAT is greater than the sum of Ta and L, thus non-conforming to the MIR, whether the packet should be dropped is determined at step 312. If the packet is determined to be dropped, a police bit is set to equal to 1 (step 316). If the packet is determined to not be dropped, the packet is colored red at step 314.

Referring back to step 306, if the TAT is less than the sum of Ta and L, thus conforming to the MIR, the packet is colored green and the TAT is set to equal TAT+I (step 308). The increment, I, is a packet inter-arrival time that varies from packet to packet. In an exemplary embodiment, I is equal to the basic time interval (Tb) multiplied by the packet size (N). The basic time interval, Tb, is the duration of a time slot for receiving a packet.

Subsequent to either steps 308 or 314, the packet color is tested at step 310. In an exemplary embodiment, if a “check input color” option is activated, the final result color from step 310 is compared to the input color (step 318). In an exemplary embodiment, the lower compliance color between the final result and the input color is the final color (step 320). If a “check input color” option is not activated, the final color is the final result color obtained at step 310 (step 320).

If a second leaky bucket is used, a copy of the same packet having a second input color is processed substantially simultaneously in the second leaky bucket (steps 322-334). If a second leaky bucket is not used, as determined at step 301, the copy is colored “null” (step 336). The color “null” indicates a higher compliance than the green color. The null color becomes the final result color for the copy and steps 318 and 320 are repeated to determine a final color for the copy.

Referring back to step 301, if a second leaky bucket is used, the TAT′ of a second leaky bucket is compared to the arrival time of the copy, Ta (step 322). In an exemplary embodiment, the TAT′ is calculated based on the CIR. If the TAT′ is less than or equal to Ta, the TAT′ is set to equal Ta (step 324). If the TAT′ is greater than Ta, the TAT′ is compared to the sum of Ta and L′ (step 326). In an exemplary embodiment, the limit, L′, is the burst tolerance (BT). Burst tolerance is calculated based on the MIR, CIR, and a maximum burst size (MBS) specified during a virtual connection set up. If the TAT′ is greater than the sum of the Ta and L′, thus non-conforming to the CIR, whether the copy should be dropped is determined at step 330. If the copy is determined to be dropped, a police bit is set to equal to 1 (step 334). Otherwise, the copy is colored yellow at step 332.

Referring back to step 326, if the TAT′ is less than or equal to the sum of the Ta and L′, thus conforming to the CIR, the copy is colored green and the TAT′ is set to equal TAT′+I′ (step 328). In an exemplary embodiment, the increment, I′, is equal to basic time interval of the copy (Tb′) multiplied by the packet size (N). Subsequent to either steps 328 or 332, the assigned color is tested at step 310. Next, if a “check input color” option is activated, the final result color is compared to the input color of the copy (step 318). The lower compliance color between the final result color and the input color is the final color (step 320). If a “check input color” option is not activated, the final color (step 320) is the final result color at step 310.

The Congestion Manager

A prior art random early detection process (RED) is a type of congestion management process. The RED process typically includes two parts: (1) an average queue size estimation; and (2) a packet drop decision. The RED process calculates the average queue size (Q_avg) using a low-pass filter and an exponential weighting constant (Wq). In addition, each calculation of the Q_avg is based on a previous queue average and the current queue size (Q_size). A new Q_avg is calculated when a packet arrives if the queue is not empty. The RED process determines whether to drop a packet using two parameters: a minimum threshold (MinTh) and a maximum threshold (MaxTh). When the Q_avg is below the MinTh, a packet is kept. When the Q_avg exceeds the MaxTh, a packet is dropped. If the Q_avg is somewhere between MinTh and MaxTh, a packet drop probability (Pb) is calculated. The Pb is a function of a maximum probability (Pm), the difference between the Q_avg and the MinTh, and the difference between the MaxTh and the MinTh. The Pm represents the upper bound of a Pb. A packet is randomly dropped based on the calculated Pb. For example, a packet is dropped if the total number of packets received is greater than or equal to a random variable (R) divided by Pb. Thus, some high priority packet may be inadvertently dropped.

In an exemplary embodiment in accordance with the invention, the congestion manager 204 applies a modified RED process (MRED). The congestion manager 204 receives packet information (i.e., packet descriptor, packet size, and packet color) from the policer 202 and performs congestion tests on a set of virtual queue parameters, i.e., per-connection, per-group, and per-port/priority. If a packet passes all of the set of congestion tests, then the packet information for that packet passes to the scheduler 206. If a packet fails one of the congestion tests, the congestion manager 204 sends signals to the packet manager 104 to drop that packet. The MRED process uses an instantaneous queue size (NQ_size) to determine whether to drop a received packet.

In an exemplary embodiment, five congestion regions are separated by four programmable levels: Pass_level, Red_level, Yel_level, and Grn_level. Each level represents a predetermined queue size. For example, all packets received when the NQ_size is less than the Pass_level are passed. Packets received when the NQ_size falls between the red, yellow, and green levels have a calculable probability of being dropped. For example, when the NQ_size is equal to 25% Red_level, 25% of packets colored red will be dropped while all packets colored yellow or green are passed. When the NQ_size exceeds the Gm level, all packets are dropped. This way, lower compliance packets are dropped before any higher compliance packet is dropped.

FIG. 4 illustrates an exemplary MRED process in accordance with an embodiment of the invention. In FIG. 4, the MRED process is weighted with three different drop preferences: red, yellow, and green. The use of three drop preferences is based on the policing output of three colors. One skilled in the art would recognize that to implement more drop preferences requires more colors from the policing output. At step 402, a packet, k, having a size “N” and a color(k) is received by the congestion manager 204. In an exemplary embodiment, the NQ_size is calculated based on the current queue size (Q_size) and the packet size (N) (step 404). The NQ_size is compared to the Gm_level (step 406). If the NQ_size is greater than or equal to the Gm_level, the packet is dropped (step 408). If the NQ_size is less than the Gm_level, the NQ_size is compared to the Pass_level (step 410). If the NQ_size is less than the Pass_level, the packet is passed (step 440). If the NQ_size is greater than the Pass_level, a probability of dropping a red packet (P_red) is determined and random numbers for each packet color are generated by a linear shift feedback register (LSFR) (step 412). Next, the NQ_size is compared to the Red_level (step 414). If the NQ_size is less than the Red_level, whether the packet color is red is determined (step 416). If the packet color is not red, the packet is passed (step 440). If the packet color is red, the P_red is compared to the random number (lsfr_r) generated by the LSFR for red packets (step 418). If the P_red is less than or equal to lsfr_r, the packet is passed (step 440). Otherwise, the packet is dropped (step 420).

Referring back to step 414, if the NQ_size is greater than or equal to the Red_level, the probability to drop a yellow packet (P_yel) is determined (step 420). Next, the NQ_size is compared to the Yel_level (step 422). If the NQ_size is less than the Yel_level, whether the packet color is yellow is determined (step 424). If the packet is yellow, the P_yel is compared to the random number (lsfr_y) generated by the LSFR for yellow packets (step 426). If the P_yel is less than or equal to lsfr_y, the packet is passed (step 440). Otherwise, the packet is dropped (step 420). Referring back to step 424, if the packet is not yellow, whether the packet is red is determined (step 428). If the packet is red, the packet is dropped (step 430). If the packet is not red, by default it is green, and the packet is passed (step 440).

Referring back to step 422, if the NQ_size is greater than or equal to Yel_level, the probability to drop a green packet (P_grn) is determined (step 432). Next, whether the packet is colored green is determined (step 434). If the packet is green, the P_gm is compared to the random number (lsfr_g) generated by the LSFR for green packets (step 436). If the P_grn is less than or equal to the lsfr_g, the packet is passed (step 440). Otherwise, the packet is dropped (step 438). At step 440, if the packet is passed, the Q_size is set to equal to NQ_size (step 442) and the process repeats for a new packet at step 402. If the packet is dropped, the process repeats for a new packet at step 402.

In an exemplary embodiment, the MRED process uses linear feedback shift registers (LFSRs) of different lengths and feedback taps to generate non-correlated random numbers. A LFSR is a sequential shift register with combinational feedback points that cause the binary value of the register to cycle through randomly. The components and functions of a LFSR are well known in the art. The LFSR is frequently used in such applications as error code detection, bit scrambling, and data compression. Because the LFSR loops through repetitive sequences of pseudo-random values, the LFSR is a good candidate for generating pseudo-random numbers. A person skilled in the art would recognize that other combinational logic devices can also be used to generate pseudo-random numbers for purposes of the invention.

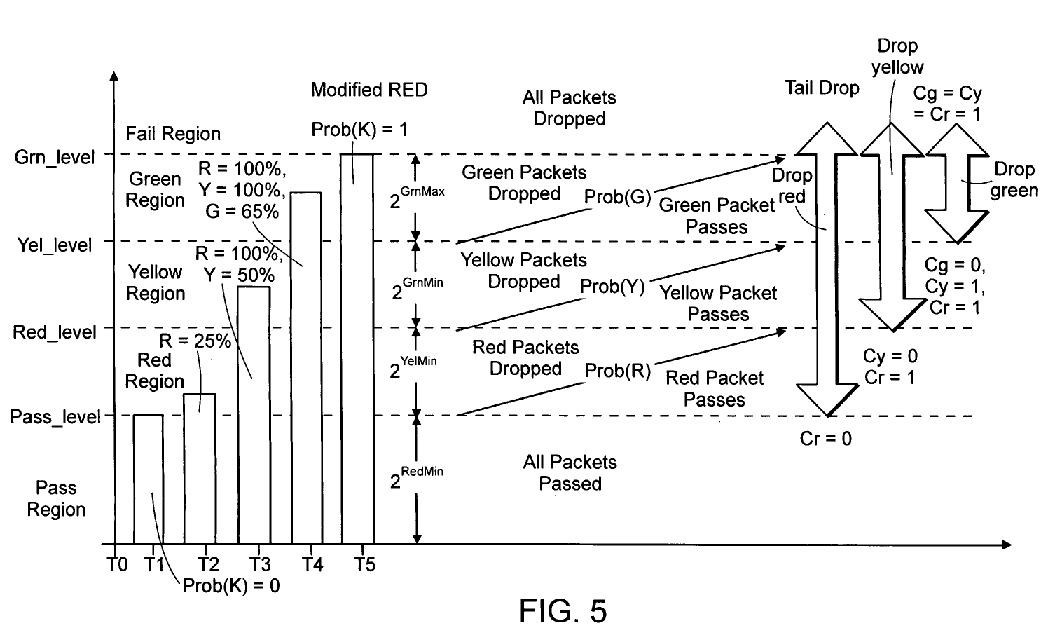

FIG. 5 provides a numerical example that illustrates the MRED process described in FIG. 4. In FIG. 5, drop regions are defined by four levels represented in the y-axis and time intervals TO-T5 are represented in the x-axis. As shown in FIG. 5, at time T1, the instantaneous queue size (NQ_size) is less than the Pass_level; thus, all received packets are passed. As shown, at T1, the probability that a packet is dropped is zero. As more packets are received than scheduled, the queue size starts to grow. If NQ_size grows past the Pass_level into the red region as shown at time T2, incoming red packets are subject to dropping. The probability of dropping red packets is determined by how far the NQ_size is within the red region. For example, at T2, the NQ_size is 25% into the red region; thus, 25% of red packets are dropped. Similarly, at T3, the NQ_size is 50% into the yellow region; thus, 50% of yellow packets are dropped and 100% of red packets are dropped. At T4, the NQ_size is 65% into the green region; thus, 65% of green packets are dropped and 100% of both red and yellow packets are dropped. At T5, the NQ_size exceeds the green region; thus, all packets are dropped and the probability that a packet is dropped is equal to one.

In another exemplary embodiment, the congestion manager 204 in accordance with the invention applies a weighted tail drop scheme (WTDS). The WTDS also uses congestion regions divided by programmable levels. However, the WTDS does not use probabilities and random numbers to make packet drop decisions. Instead, every packet having the same color is dropped when a congestion level for such color exceeds a predetermined threshold.

FIG. 6 illustrates an exemplary WTDS process in accordance with an embodiment of the invention. Assuming three levels of drop preferences: red, yellow, and green, in the order of increasing compliance. In an exemplary embodiment, similar to the MRED process, the WTDS process designates the region above the Gm_level as a fail region where all packets are dropped. A packet k having a packet size N and color(k) is received at step 602. The NQ_size is calculated to equal the sum of Q_size and N (step 604). Next, the NQ_size is compared to the Grn_level (step 606). If the NQ_size is greater than or equal to the Gm_level, the packet is dropped and a green congestion level bit (Cg) is set to one (step 608). When the Cg bit is set to 1, all packets, regardless of color, are dropped. If the NQ_size is less than the Grn_level, the NQ_size is compared to the Pass_level (step 610). If the NQ_size is less than the Pass_level, then a red congestion level bit (Cr) is set to zero (step 612). When the Cr bit is set to zero, all packets, regardless of color, are passed.

Referring back to step 610, if the NQ_size is greater than or equal to the Pass_level, the NQ_size is compared to the Red_level (step 614). If the NQ_size is less than the Red_level, the Cy bit is set to zero (step 616). Next, whether the packet is colored red is determined (step 618). If the packet is red, whether the Cr bit is equal to 1 is determined. If the Cr bit is equal to 1, the red packet is dropped (steps 622 and 646). If the Cr bit is not equal to 1, the red packet is passed (step 646). Referring back to step 618, if the packet is not red, the packet is passed (step 646).

Referring back to step 614, if the NQ_size is greater than or equal to the Red_level, the Cr bit is set to one (step 624). Next, the NQ_size is compared to the Yel_level (step 626). If the NQ_size is less than the Yel_level, the Cg bit is set to equal zero (step 628). Next, whether the packet is colored yellow is determined (step 630). If the packet is yellow, it is determined whether the Cy bit is equal to 1 (step 632). If Cy is not equal to 1, the yellow packet is passed (step 646). If Cy is equal to 1, the yellow packet is dropped (steps 634 and 646). Referring back to step 630, if the packet is not yellow, whether the packet is red is determined (step 636). If the packet is red, it is dropped (steps 634 and 646). Otherwise, the packet is green by default and is passed (step 646).

Referring back to step 626, if the NQ_size is greater than or equal to the Yel_level, the Cy bit is set to equal to 1 (step 638). Next, whether the packet is green is determined (step 640). If the packet is not green, the packet is dropped (step 642). If the packet is green, whether the Cg bit is equal to one is determined (step 644). If the Cg bit is one, the green packet is dropped (steps 642 and 646). If the Cg bit is not equal to one, the green packet is passed (step 646). At step 646, if the current packet is dropped, the process repeats at step 602 for a new packet. If the current packet is passed, the Q_size is set to equal the NQ_size (step 648) and the process repeats for the next packet.

In an exemplary embodiment, in addition to congestion management per connection, per group, and per port/priority, the congestion manager 204 provides chip-wide congestion management based on the amount of free (unused) memory space on a chip. The free memory space information is typically provided by the packet manager 104 to the packet scheduler 106. In one embodiment, the congestion manager 204 reserves a certain amount of the free memory space for each priority of traffic.

The Scheduler

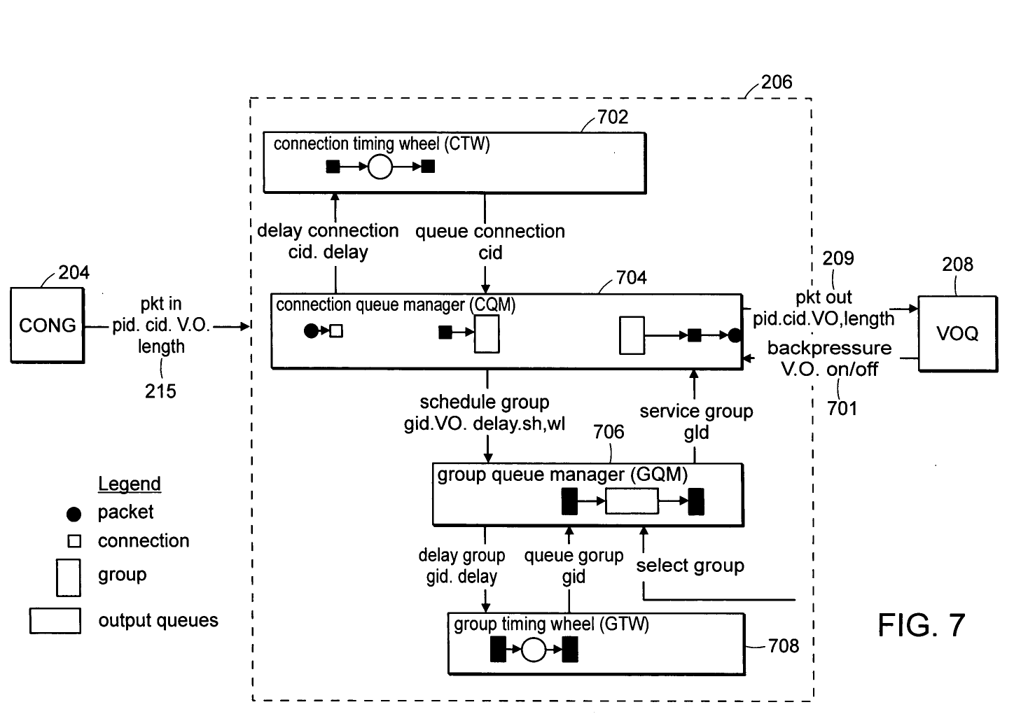

FIG. 7 illustrates an exemplary scheduler 206 in accordance with an embodiment of the invention. The scheduler 206 includes a connection timing wheel (CTW) 702, a connection queue manager (CQM) 704, a group queue manager (GQM) 706, and a group timing wheel (GTW) 708.

Packet information (including a packet descriptor) is received by the scheduler 206 from the congestion manager 204 via the signal line 215. In an exemplary embodiment, packet information includes packet PID, ICID, assigned VO, and packet size. Scheduled packet information is sent from the scheduler 206 to the VOQ handler 208 via the signal line 209 (see FIG. 2).

A connection may be shaped to a specified rate (shaped connection) and/or may be given a weighted share of its group's excess bandwidth (weighted connection). In an exemplary embodiment, a connection may be both shaped and weighted. Each connection belongs to a group. In an exemplary embodiment, a group contains a FIFO queue for shaped connections (the shaped-connection FIFO queue) and a DRR queue for weighted connections (the weighted-connection DRR queue).

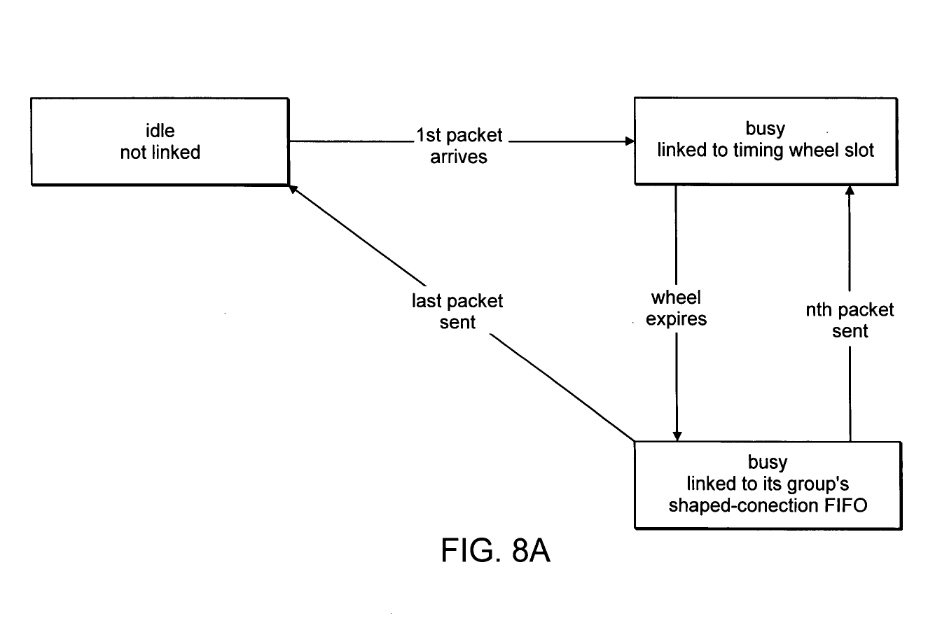

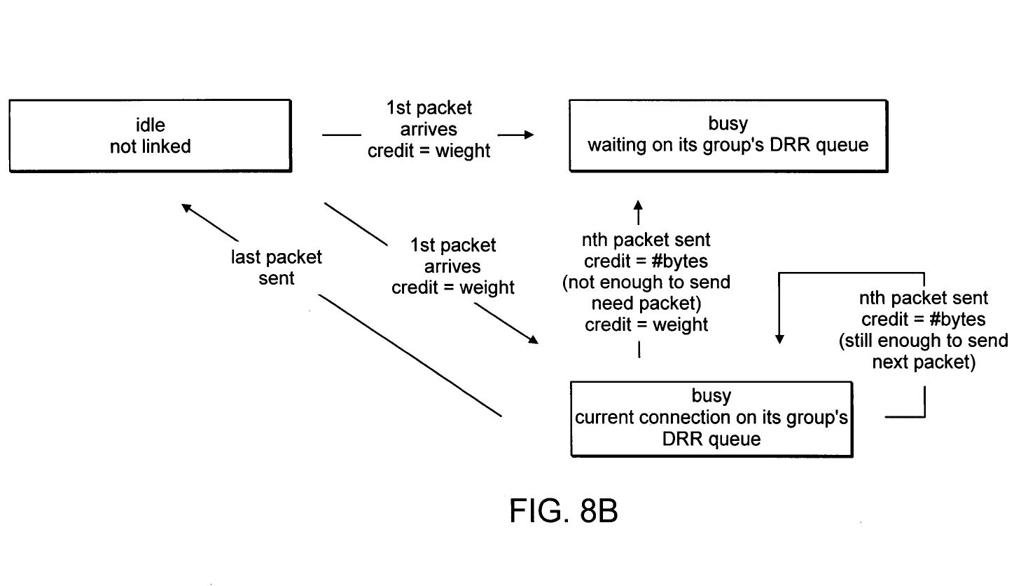

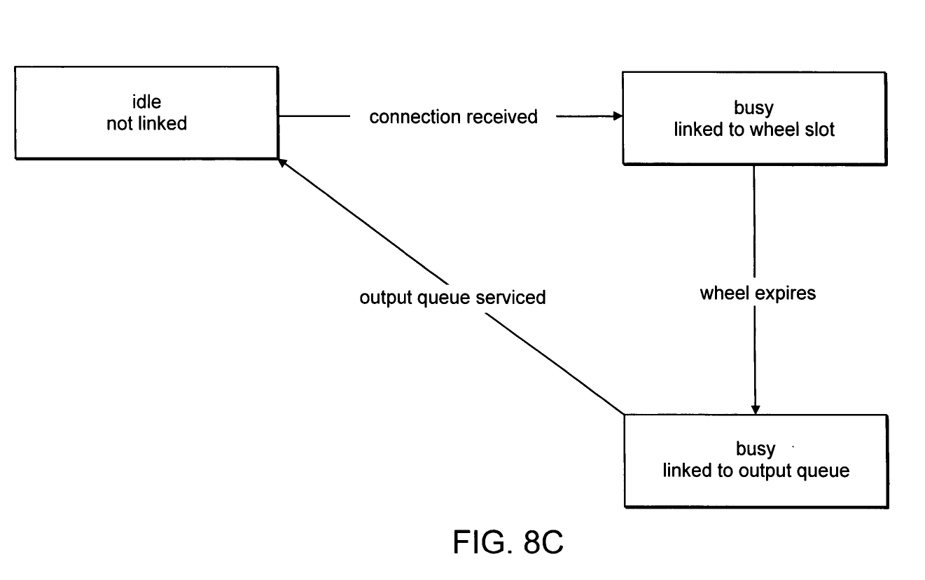

In an exemplary embodiment, a PID that arrives at an idle shaped connection is queued on a ICID queue. The ICID queue is delayed on the CTW 702 until the packet's calculated TAT occurs or until the next time slot, whichever occurs later. In an exemplary embodiment, the CTW 702 includes a fine timing wheel and a coarse timing wheel, whereby the ICID queue is first delayed on the coarse timing wheel then delayed on the fine timing wheel depending on the required delay. After the TAT occurs, the shaped connection expires from the CTW 702 and the ICID is queued on the shaped connection's group shaped-connection FIFO. When a shaped connection is serviced (i.e., by sending a PID from that shaped connection), a new TAT is calculated. The new TAT is calculated based on the packet size associated with the sent PID and the connection's configured rate. If the shaped connection has more PIDs to be sent, the shaped connection remains busy; otherwise, the shaped connection becomes idle. The described states of a shaped connection are illustrated in FIG. 8A.

A weighted connection is configured with a weight, which represents the number of bytes the weighted connection is allowed to send in each round. In an exemplary embodiment, an idle weighted connection becomes busy when a PID arrives. When the weighted connection is busy, it is linked to its group's DRR queue; thus, the PID is queued on an ICID queue of the connection's group DRR queue. A weighted connection at the head of the DRR queue can send its PIDs. Such weighted connection remains at the head of the DRR queue until it runs out of PIDs or runs out of credit. If the head weighted connection runs out of credit first, another round of credit is provided but the weighted connection is moved to the end of the DRR queue. The described states of a weighted connection are illustrated in FIG. 8B.

A group is shaped at a configured maximum rate (e.g., 10 G bytes). As described above, each group has a shaped-connection FIFO and a DRR queue. Within a group, the shaped-connection FIFO has service priority over the weighted-connection DRR queue. In addition, each group has an assigned priority. Within groups having the same priority, the groups having shaped connections have service priority over the groups having only weighted connections.

In an exemplary embodiment, the CQM 704 signals the GQM 706 via a signal line 707 to “push,” “pop,” and/or “expire.” The signal to push is sent when a connection is queued on the DRR queue of a previously idle group. The signal to pop is sent when the CQM 704 has sent a packet from a group that has multiple packets to be sent. The signal to expire is sent when a connection expires from the CTW 702 and the connection is the first shaped connection to be queued on a group's shaped-connections FIFO.

In an exemplary embodiment, the GQM 706 may delay a group on the GTW 708, if necessary, until the group's TAT occurs. In an exemplary embodiment, the GTW 702 includes a fine group timing wheel and a coarse group timing wheel, whereby a group is first delayed on the coarse group timing wheel then delayed on the fine group timing wheel depending on the required delay. When a group's TAT occurs, the group expires from the GTW 708 and is queued in an output queue (either a shaped output queue or a weighted output queue). In one embodiment, when a group in an output queue is serviced, a PID from that group is sent out by the CQM 702.

In another embodiment, the CQM 702 may signal a group to “expire” while the group is already on the GTW 708 or in an output queue. This may happen when a group which formerly had only weighted connections is getting a shaped connection off the CTW 702. Thus, if such a group is currently queued on a (lower priority) weighted output queue, it should be requeued to a (higher priority) shaped output queue. The described states of a group are illustrated in FIG. 8C.

In an exemplary embodiment, each group output queue feeds a virtual output queue (VOQ) controlled by the VOQ handler 208. Each VOQ can accept a set of PIDs depending on its capacity. In one embodiment, if a group output queue continues to feed a VOQ after its capacity has been exceeded, the VOQ handler 208 signals the scheduler 206 to back-pressure PIDs from that group output queue via a signal line 701.

In an exemplary embodiment, the use of fine and coarse timing wheels at the connection and group levels allow the implementation of the unspecified bit rate (UBR or UBR+) traffic class. When implementing the UBR+traffic class, the packet scheduler 106 guarantees a minimum bandwidth for each connection in a group and limits each group to a maximum bandwidth. The fine and coarse connection and group wheels function to promote a below-minimum-bandwidth connection within a group to a higher priority relative to over-minimum-bandwidth connections within the group and promote a group containing below-minimum-bandwidth connections to a higher priority relative to other groups containing all over-minimum-bandwidth connections.

The Virtual Output Queue

Referring back to FIG. 2, a scheduled packet PID, identified by the sch-to-voq signals via signal line 209 to the VOQ handler 208, is queued at one of a set of virtual output queues (VOQs). The VOQ handler 208 uses a feedback signal 213 from the packet manager 104 to select a PIED from a VOQ. The VOQ handler 208 then instructs the packet manager 104, by voq-to-pm signals via signal line 211, to transmit a packet associated with the selected PID stored in the VOQ. In an exemplary embodiment, VOQs are allocated in an internal memory.

If a packet to be transmitted has a multicast source, then the VOQ handler 208 uses a leaf table to generate multicast leaf PIDs. In general, multicast leaf PIDs are handled the same way as regular (unicast) PIDs. In an exemplary embodiment, the leaf table is allocated in an external memory.

In an exemplary embodiment, the packet scheduler 106 supports multicast source PIDs in both the ingress and egress directions. A multicast source PID is generated by the packet processor 102 and identified by the packet scheduler 106 via a packet PID's designated output port number. In an exemplary embodiment, any PIED destined to pass through a designated output port in the VOQ handler 208 is recognized as a multicast source PID. In an exemplary embodiment, leaf PIDs for each multicast source PID are generated and returned to the input of the packet scheduler 106 via a VOQ FIFO to be processed as regular (unicast) PIDS.

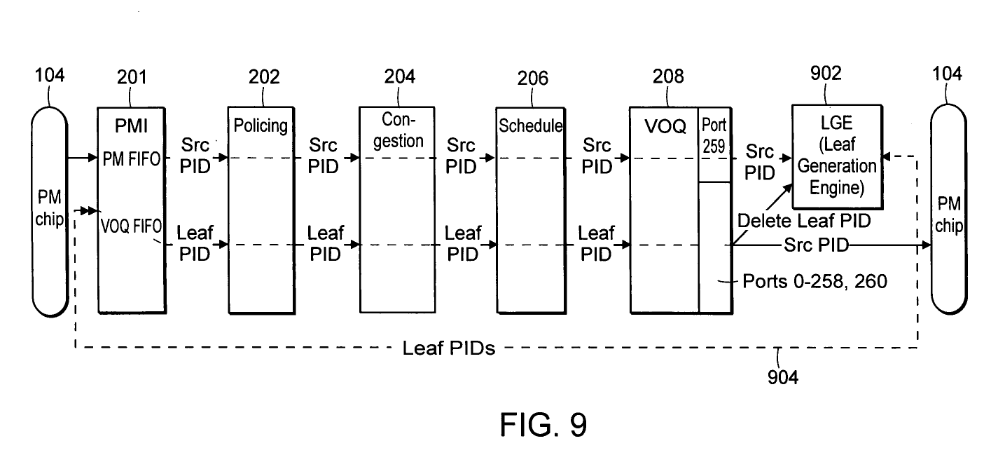

FIG. 9 illustrates an exemplary packet scheduler 106 that processes multicast flows. The packet scheduler 106 includes all the components as described above in FIG. 2 plus a leaf generation engine (LGE) 902, which is controlled by the VOQ handler 208. Upon receiving a multicast source PID from the VOQ handler 208, the LGE 902 generates leaf PIDs (or leaves) for that multicast source PID. In an exemplary embodiment, the LGE 902 processes one source PID at a time. When the LGE 902 is generating leaf PIDs for a source PID, the VOQ handler 208 interprets the VOQ output port 259 (or the designated multicast port) as being busy; thus, the VOQ handler 208 does not send any more source PIDs to the LGE 902. When the LGE 902 becomes idle, the VOQ handler 208 sends the highest priority source PID available. In one embodiment, after a source PID is sent to the LGE 902, the source PID is unlinked from the VOQ output port 259.

In an exemplary embodiment, the LGE 902 inserts an ICID and an OCID to each leaf. As shown in FIG. 9 via signal line 904, generated leaves are returned to the beginning of the packet scheduler 106 to be processed by the policer 202, the congestion manager 204, the scheduler 206 and the VOQ handler 208 like any regular (unicast) PIDs. Later, the processed leaves (or leaf PIDs) are sent to the packet manager 104 using the original multicast source PID. In an exemplary embodiment, a multicast source PID is referenced by leaf data. Leaf data contains the source PID, OCID, and a use count.

In an exemplary embodiment, the use count is maintained in the first leaf allocated to a multicast source PID. All other leaves for the source PID references the use count in the first leaf via a use count index. In one embodiment, the use count is incremented by one at the beginning of the process and for each leaf allocated. After the last leaf is allocated, the use count is decremented by one to terminate the process. The extra increment/decrement (in the beginning and end of the process) ensures that the use count does not become zero before all leaves are allocated. Using the use count also limits the number of leaves generated for any source PID. In one embodiment, if the use count limit is exceeded, the leaf generation is terminated, a global error count is incremented, and the source CID is stored.

In an exemplary embodiment, leaf PIDs are used to provide traffic engineering (i.e., policing, congestion management, and scheduling) for each leaf independently. In an exemplary embodiment, the VOQ handler 208 identifies a leaf by a leaf PID. After all the leaf PIDs of a source PID have been processed, the VOQ handler 208 sends the source PID information (e.g., source PID, OCID) to the packet manager 104 to instruct the packet manager 104 to send the source PID.

Since leaf PIDs pass through the same traffic engineering blocks (i.e., policer 202, congestion manager 204, and scheduler 206) as regular (unicast) PIDs, some leaf PIDs may be dropped along the way. In one embodiment, each drop signal is intercepted by the VOQ handler 208 from the congestion manager 204. If the signal is to drop a regular PID, the drop signal passes to the packet manager 104 unaltered. If the signal is to drop a leaf PID, the signal is sent to a leaf drop FIFO. The leaf drop FIFO is periodically scanned by the VOQ handler 208. If a signal to drop a leaf PID is received by the VOQ handler 208, the use count associated with that leaf PID is decremented and the leaf is idled. If the use count is equal to zero, then the source PID for that leaf PID is also idled and a signal is sent to the packet manager 104 to not send/delay drop that source PID.

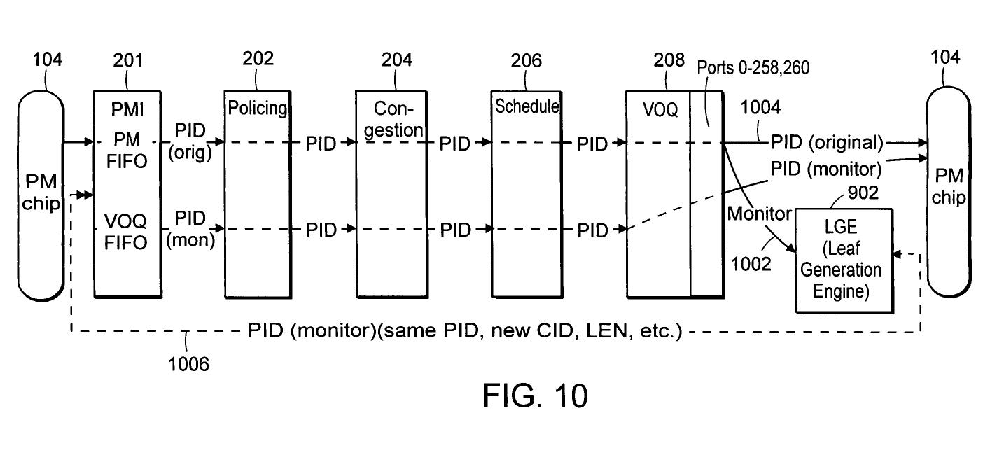

In another exemplary embodiment, the VOQ handler 208 is configured to process monitor PIDs in the ingress direction. A monitor PID allows an original PID to be sent to both its destination and a designated port. FIG. 10 illustrates an exemplary packet scheduler 106 for processing monitor PIDs in accordance with an embodiment of the invention. The packet scheduler in FIG. 10 includes all the components as described above in FIG. 9. Generally, a monitor flow (including monitor PIDs) is processed similarly to a multicast flow (including multicast source PIDs). A monitor PID is processed by all traffic engineering blocks (i.e., the policer 202, the congestion manager 204, etc.) and is scheduled as any regular (unicast) PID. In an exemplary embodiment, a monitor PID is generated after its associated original PID is sent. An original PID provides monitor code for generating a monitor PID as the original PID is being passed to the packet manager 104 by signal lines 1002 and 1004. In an exemplary embodiment, the monitor code from each original PID is stored in a monitor table. In one embodiment, the VOQ handler 208 accesses the monitor code in the monitor table to generate a monitor PID. The generated monitor PID is passed through the traffic engineering blocks via a signal line 1006.

In an exemplary embodiment, the generated monitor PID includes a monitor bit for identification purposes. In one embodiment, the VOQ FIFO stops receiving multicast leaf PIDs when the VOQ FIFO is half full, thus, reserving half of the FIFO for monitor PIDs. In an exemplary embodiment, if the VOQ FIFO is full, the next monitor PID fails and is not sent. Generally, such next monitor PID is not queued elsewhere. Further, if the VOQ FIFO is full, a monitor PID is sent to the packet manager 104 with instruction to not send/delay drop and a monitor fail count is incremented. In an exemplary embodiment, the LGE 902 arbitrates storage of multicast leaf PIDs and monitor PIDs into the VOQ FIFO. In one embodiment, a monitor PID has priority over a multicast leaf. Thus, if a monitor PID is received by the LGE 902, the leaf generation for a multicast source PID is stalled until the next clock period.

Referring back to FIG. 5, the levels located on the y-axis (Pass_level, Red_level, Yel_level and Grn_level) represent various example congestion thresholds employed by the congestion management process of FIG. 4, which, again, is a modified Random Early Detection (MRED) process. Through this process, each incoming packet to a router (or other network device) employing the congestion thresholds is evaluated for passing through the egress output of the router, and passage is determined by the packet size (N), packet color (k), and the current size of the output queue (Q_size) at the Virtual Output Queue (VOQ). As described above, the congestion manager 204 receives packet information from the policer 202 and performs congestion tests on a set of virtual queue parameters, i.e., per-connection, per-group, and per-port/priority.

Further embodiments of the present invention employ such a three-tiered hierarchy of packets, wherein each packet may be identified by a connection identifier (CID, also referred to as an input connection identifier (ICID)), and packets of multiple data flows may be organized into a single group of data flow, designated by a group identifier (GID). Further, a single VOQ may receive packets from multiple groups. Multiple VOQs may pass traffic to a physical port. Thus, in addition to packet size and color, the congestion manager 204 may also evaluate each packet based on CID, GID, and VOQ. Because each packet may be identified in three hierarchical levels, the congestion manager may apply congestion thresholds to a packet based on its flow, group(s), and VOQ.

Under such an arrangement, the congestion management process of FIG. 4 and illustrated in FIG. 5 applies to CID's, GID's and VOQ's in a hierarchical manner. Each resource has its own set of thresholds and bytecounts (bytes of data queued), and the bytecounts are summed across the resources. For example, if there are 10 CID's for the same GID each with a byte count of 100, then the GID bytecount is 100×10=1000 bytes. Similarly, if there are 3 GID's to a VOQ (port+priority), then the VOQ bytecount is the sum of all 3 GIDs' bytecounts to that VOQ. When a packet is accepted (i.e. not dropped), the bytecounts of the associated CID, GID and VOQ are incremented by the packet size at the same time. Likewise, when the packet is transmitted, the bytecounts of the CID, GID and VOQ are decremented by the packet size.

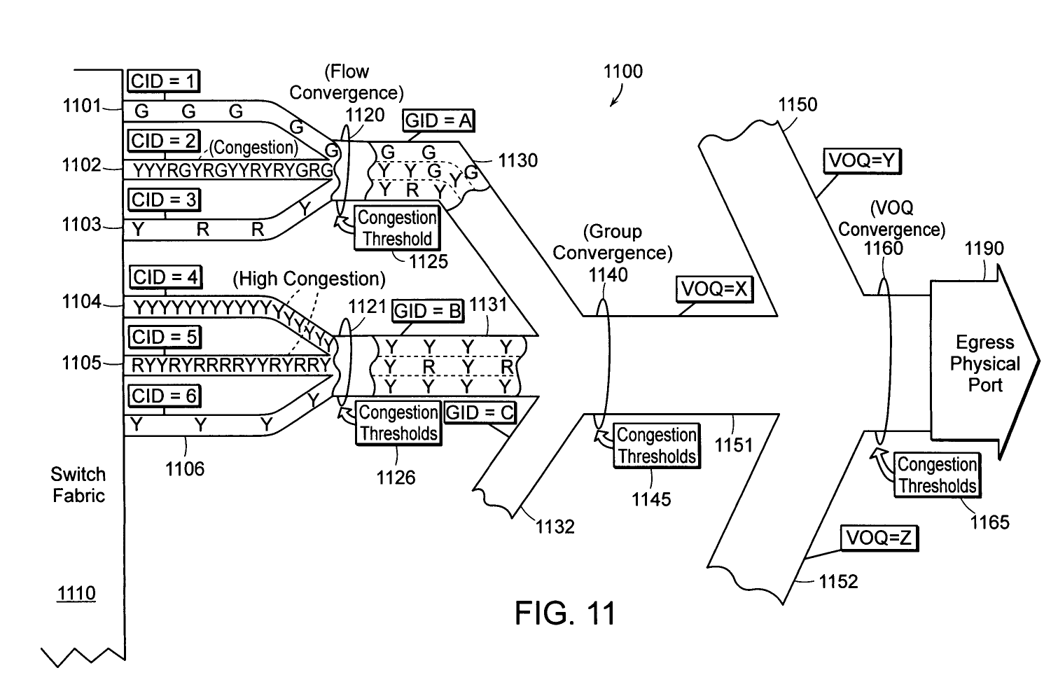

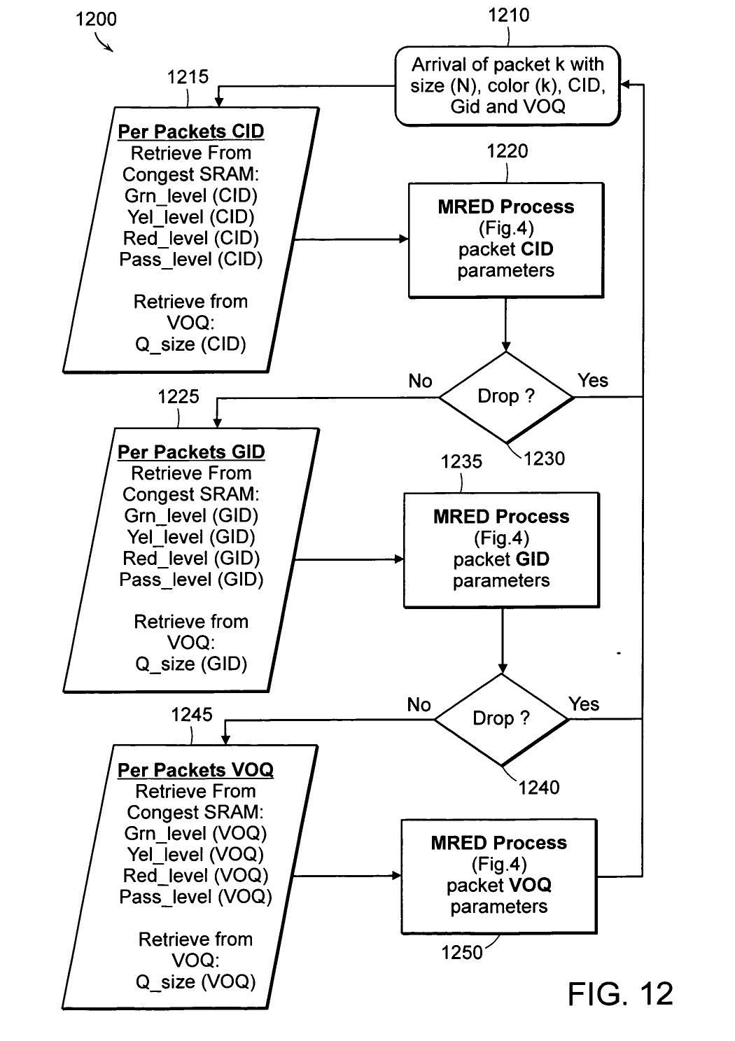

FIG. 11 is a visual depiction of an exemplary congestion management process 1100 among a hierarchy of egress communications. Individual packet flows 1101-1106 are shown as conduits carrying packets from a switch fabric 1110 to an egress physical port 1190 for transmittal across a network (not shown). The packets are depicted by a letter designating their colors: [R]=red; [Y]=yellow; [G]=green. Each packet flow 1101-1106 has a unique connection identifier, shown as [CID=1] . . . [CID=6], respectively.

The packet flows 1101-1106 converge at flow convergence points 1120, 1121 into multiple groups 1130-1132, each of which being identified by a unique group identifier, shown as [GID=A], [GID=B], and [GID=C], respectively. For clarity, the multiple packets converging into a third group, group 1132, are not shown, but may have the same or similar structure as the groups, groups 1130, 1131, that are shown.

At a group convergence point 1140, the multiple groups 1130-1132 converge into a single VOQ 1151 having a unique VOQ identifier, shown as [VOQ=X]. Other VOQ's 1150, 1152 have identifiers [VOQ=Y] and [VOQ=Z], respectively. These VOQ's 1150, 1152 are shown absent their respective flows and groups, but may have the same or similar structure preceding VOQ 1151.

At the VOQ convergence point 1160, the VOQ's 1150, 1151, 1152 converge into a single physical port 1190. Depending on the desired configuration, a single physical port 1190 may have a greater or lesser number of VOQ's than the three VOQ's shown. Similarly, a single VOQ may have any quantity of groups, and each group may have any number of packet flows, providing that the traffic management system is capable of operating under such an organization.

At each flow convergence point 1120, 1121, the congestion manager, such as congestion manager 204 of FIG. 2, may apply congestion thresholds 1125, 1126 to each packet that reaches the flow convergence points 1120, 1121. These congestion thresholds 1125, 1126 may be configured in a number of ways to control the flow of packets through each group 1130, 1131. Likewise, the congestion manager may also apply congestion thresholds 1145, 1165 to the group and VOQ convergence points 1140, 1160, respectively.

Some or all of the aforementioned thresholds may be configured to satisfy a number of example criteria in controlling the flow of the packets. For example, the congestion manager may be configured to ensure that all high-priority traffic from one or more packet flows (such as a first flow 1101) is transmitted, despite congestion caused by a second flow (1102) in the same VOQ or group. Similarly, it may be necessary to guarantee passage of high-priority traffic on a congested flow (such as the green packets [G] of the second flow 1102). It may also be useful to allow some lower-priority traffic on a non-congesting line (such as in a third flow 1103) to pass through, despite heavy traffic in other packet flows (such as second, third, fourth and fifth flows 1102, 1104 and 1105, respectively). It may also be useful to isolate packet flows causing congestion (such as the fourth and fifth flows 1104, 1105) so that they do not cause packets in other flows to be dropped. The aforementioned example criteria, as well as other possible criteria in controlling network traffic, may be obtained by properly configuring the congestion manager to apply particular thresholds to this network traffic.

The diagram of FIG. 11 provides a conceptual overview of one exemplary congestion management process. In an example embodiment of this process 1100, multiple packet flows do not physically converge, nor are they subject to congestion management at multiple different points. Rather, the multiple data flows may converge by sharing one or more of the same identifiers or arriving at the same output queue. Further, the congestion management process 1100 may apply thresholds on a per-packet basis by the identifiers associated with each packet. One such process is depicted by the flow diagram of FIG. 12, discussed below.

FIG. 12 illustrates a process 1200 that expands the MRED process of FIG. 4 for managing congestion of a hierarchy of packet flows. For each packet arriving at the packet scheduler, such as the packet scheduler 122 of FIG. 1, a packet descriptor indicating packet size (N) and color (k) is first received (1210) by the congestion manager, such as the congestion manager 204 of FIG. 2. The descriptor also includes the identifiers CID, GID and VOQ, indicating the packet's place within the hierarchy of packet flows. The congestion manager retrieves (1215) the threshold values corresponding to the packet CID, as well as the current queue size for that CID. Using these values, the MRED process of FIG. 4, for example, is applied (1220). At this stage, the instantaneous queue size (NQ_size) is calculated based on the packet size (N) and the current CID queue size (Q_size). The NQ_size is compared to the threshold values of the CID, and, if the NQ_size is larger than the minimum threshold of the packet color (k), the packet is subject to being dropped. If the packet is dropped (1230), the congestion manager repeats the process 1200 for a subsequent packet. If the packet is not dropped, the packet is further evaluated based on its GID by first retrieving the threshold levels and queue size for the corresponding GID at step 1225. The congestion manager may employ the aforementioned MRED process using the GID parameters (1235). If the packet is not dropped (1240), the process repeats one last time (1245, 1250) to evaluate the packet based on corresponding VOQ parameters.

The expanded MRED process 1200 of FIG. 12 may be modified in a number of ways to accommodate different design parameters. For example, the MRED process calls (1220, 1235 and 1250) may be combined by evaluating all parameters of the packet simultaneously. In such an example, the congestion manager can first obtain all parameters for the packet CID, GID and VOQ, and then apply all thresholds to the packet in parallel. This approach may result in faster congestion management. The process 1200 may also be completed in a different order than shown, whereby the packet may be evaluated under GID or VOQ parameters before CID parameters. However, in an example embodiment, all packets are more likely to be dropped based on CID parameters than under other parameters. Thus, first evaluating CID parameters may maximize efficiency of the process 1200 by dropping packets at a flow convergence point 1120, 1121 more quickly than at a group convergence point 1140 or VOQ convergence point 1160.

The process 1200 of FIG. 12 may also accommodate a number of different threshold configurations. For example, congestion thresholds may be identical among all CID, GID and VOQ thresholds. Under such a configuration (an “identical” threshold configuration), the congestion manager 204 evaluates all packet descriptors under the same thresholds for each VOQ. As a result, a minimum transfer rate may be ensured by first dropping lower-priority packets across all flows to the VOQ. In reference to FIG. 5, for example, a packet descriptor may arrive at the congestion manager 204 (FIG. 2) with a yellow color and a given CID, GID and VOQ. In the identical threshold configuration example, all CID, GID and VOQ queues have the same values for each threshold level (Pass_level, Red_Level, Yel_Level and Grn_level). Thus, if the queue size exceeds the threshold Yel_level, then all yellow packets are subject to being dropped. As a further example, the Red_Level threshold to a VOQ is reached simultaneously by all CID's, and, thus, all red packets are subject to dropping, thereby allowing the guaranteed minimum rate packets (e.g., green packets) to be transmitted.

While configuring congestion thresholds to be identical among all CID's, GID's and VOQ's may be effective in controlling some forms of congestion, it is also limited in several ways. One such limitation is in the ability to control multiple flows competing for the same output. For example, a single flow of lower-priority (red and yellow) traffic may cause congestion on a VOQ by filling the queue with packets, thereby causing the queue to reach the Grn_Level threshold. As a result, all lower-priority packets from other flows to the same VOQ will be dropped. A single high-traffic flow can therefore interrupt traffic from all other flows to the same output.

Moreover, this configuration may cause complications when different flows are distinguished by different priority traffic. For example, a first flow may consist entirely of yellow packets, and a second flow may consist entirely of red packets, where both flows share the same VOQ. If the first flow passes an excess of traffic causing congestion, the queue may reach the Yel_level threshold, causing all packets of the second flow to be dropped. While the system is configured to drop lower-priority traffic first, it may be impossible to drop all traffic from a particular flow.

Another disadvantage of such an “identical” configuration is that some packets may be subject to a higher probability of being dropped than desired. For example, a packet with a yellow color may arrive at the congestion manager when the CID queue is in the middle of the “yellow” region of the thresholds, as shown at time T3 in FIG. 5. Due to the CID threshold, the packet has approximately a 50% chance of being dropped. However, if the corresponding group and VOQ are similarly congested, then the packet would also be subject to an additional 75% chance of being dropped. As a result, the pass rate for such packets would be approximately 12.5%, which may be lower than necessary to manage congestion.

Some disadvantages of the “identical” threshold configuration may be obviated by instead configuring the congestion thresholds at different levels for CID's, GID's and VOQ's. Namely, the thresholds can be configured so that for each threshold, the value at each CID is less than the value at each GID, and the value at each GID is less than the value at the VOQ. Such a configuration may be referred to as a dynamic configuration rather than an identical configuration.

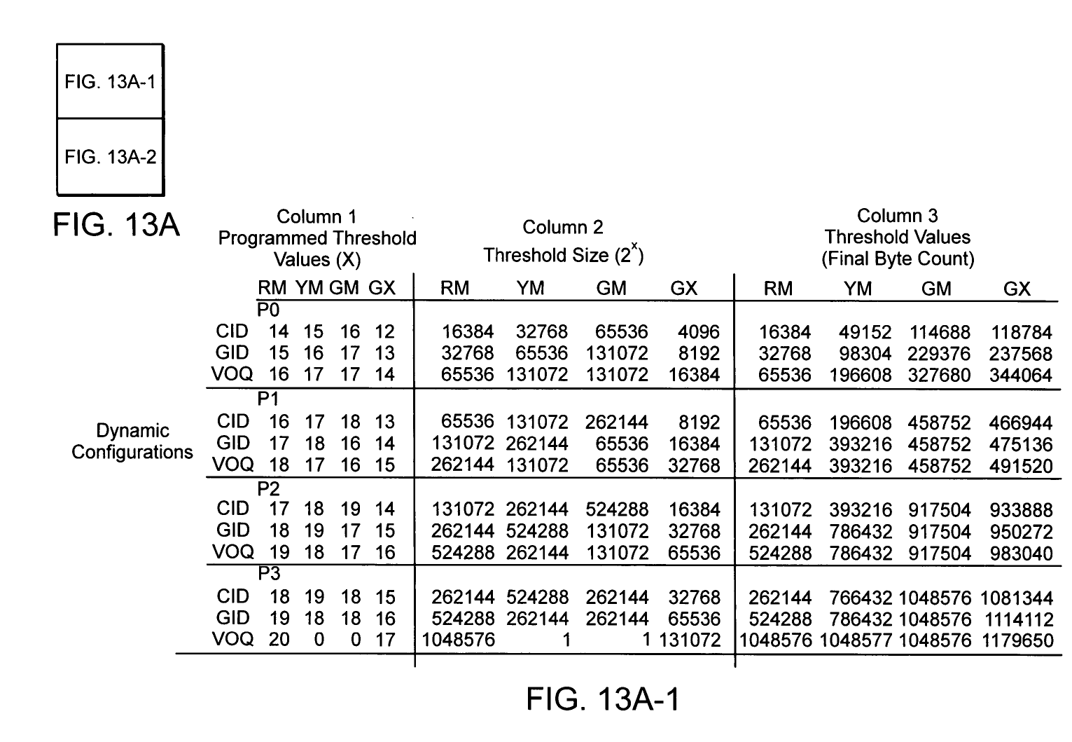

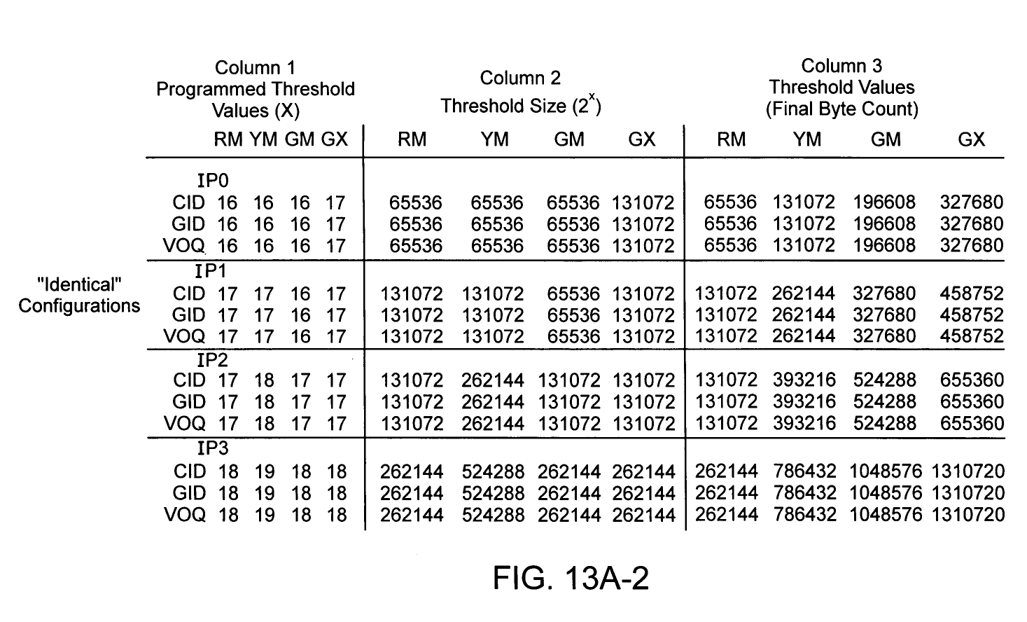

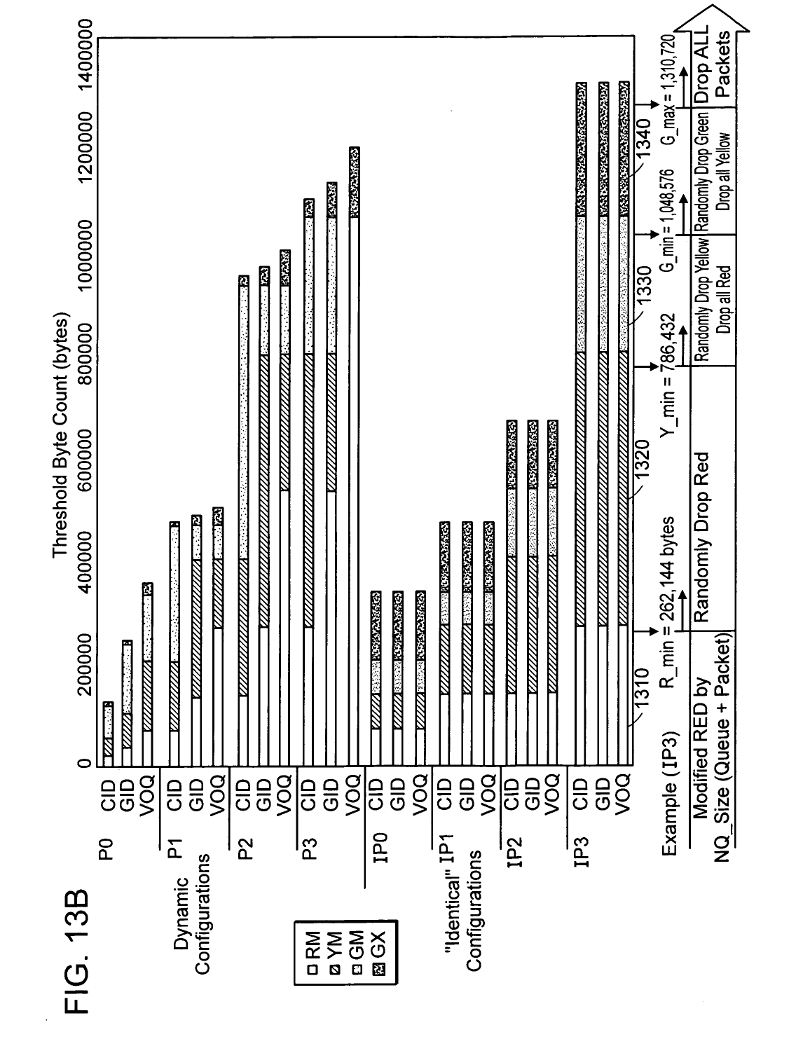

FIG. 13A is a congestion table, and FIG. 13B is a corresponding graph, illustrating eight different configurations of congestion thresholds. In FIG. 13A, column 1, each configuration is designated by a priority, P0-P3, where P0 is the highest priority and P3 is the lowest priority in this example. Similarly, each “identical” configuration is designated by a priority, IP0-IP3, where the identical configurations (IP0-IP3) are located at the bottom of the table and the dynamic configurations (P0-P3) are located at the top. Column 1 includes programmed threshold values (X), which are the values entered to configure the congestion manager. For example, identical configuration IP0 includes programmed values of 16 for all red, yellow and green minimum thresholds, and 17 for all green maximum thresholds. Because IP0 is an “identical” configuration, the values for each threshold level are identical for all CID, GID and VOQ queues (hereinafter referred to as CID, GID and VOQ, respectively). A system may be adapted so that, if programmed threshold values are not entered for each CID, GID or VOQ, or if thresholds are not configured or partially configured, then an identical configuration is instead utilized.

Column 2 of FIG. 13A includes the threshold sizes corresponding to the programmed threshold values, in bytes. Each threshold size is calculated as equal to 2ˆX, where X is the programmed threshold value in Column 1. Column 3 includes the final byte count of each congestion threshold, which is derived by summing each threshold size with the thresholds preceding it. For example, the final byte count of the green minimum threshold (GM) is the sum of the red (RM), yellow (YM) and green (GM) threshold sizes of Column 2.

FIG. 13B is a graph illustrating the congestion configurations programmed in the congestion table in FIG. 13A. For each configuration, a bar representing a minimum and maximum threshold range of each CID, GID and VOQ is shown, indicating the byte count of each threshold. For identical configuration priority IP3, for example, the CID thresholds show first a region 1310 below the red minimum threshold RM (262,244 bytes), under which all packets may be passed. To the immediate right of this region 1310 is a black bar bounded by the red minimum (RM) threshold and the yellow minimum (YM) threshold (786,432 bytes) indicating a second region 1320 between the red minimum (RM) threshold and the yellow minimum (YM) threshold, within which red packets may be dropped. Adjacent to the right of the second region 1320 is a third region bounded by the YM threshold and the green minimum (GM) threshold, within which all red packets are dropped and yellow packets may be dropped. Lastly, the rightmost region between GM and the green maximum (GX) threshold is a region where all red and yellow packets are dropped, and green packets may be dropped. Above this green maximum (GX) threshold (a byte count of 1,310,720 for the configuration IP3), all red, yellow and green packets dropped. Because IP3 is an “identical” configuration, the threshold regions are identical for each CID, GID and VOQ.

The dynamic configurations for priorities P0-P3 of FIG. 13B are exemplary threshold configurations that may traverse some of the aforementioned limitations of identical configurations. In particular, configurations P0-P3 balance two example design criteria: 1) guarantee passage of one subset of communications traffic, the subset being all green packets (or other color(s)); and 2) control interference among independent flows that are competing to pass through the system. In general, these example criteria may be met in particular dynamic configurations, resulting in improved congestion management and traffic performance for many applications.

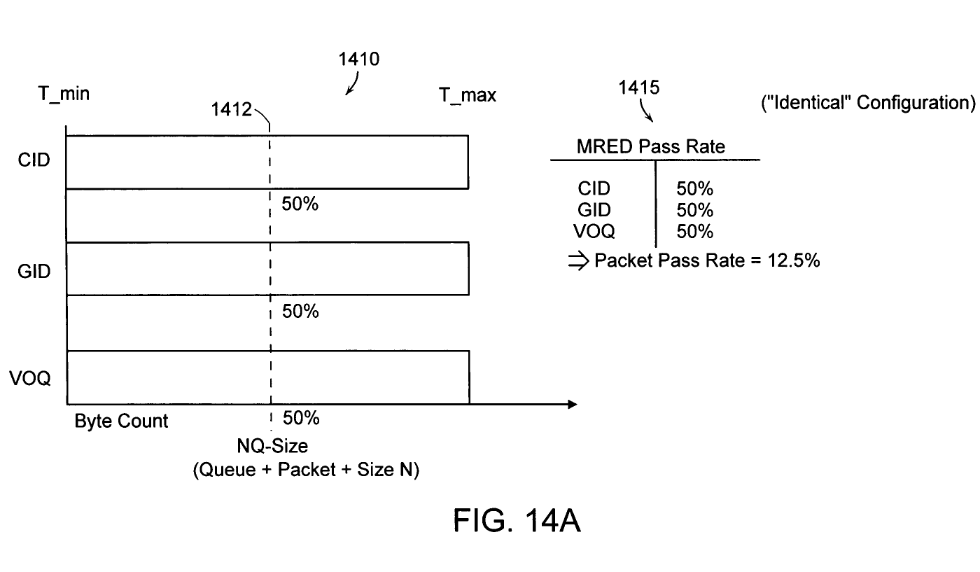

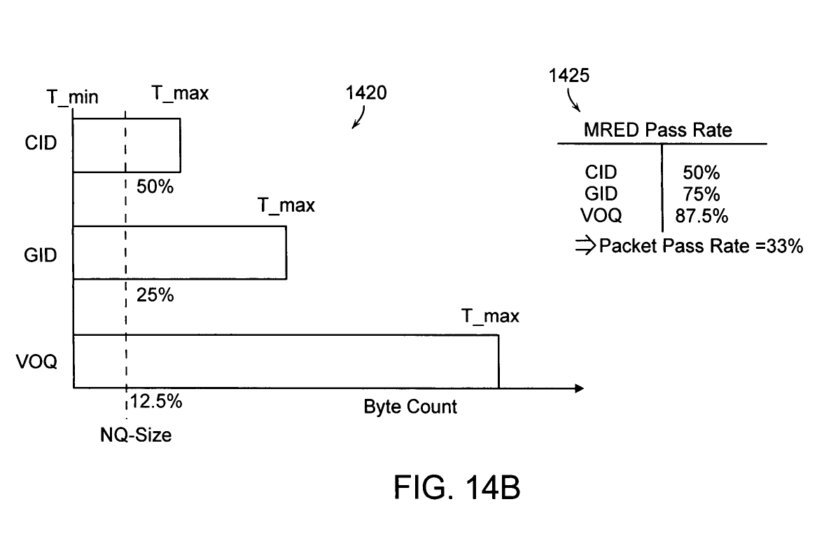

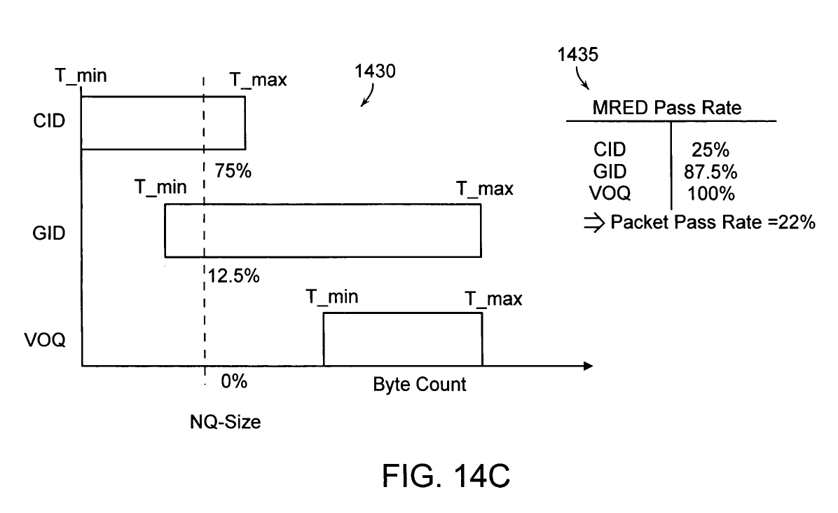

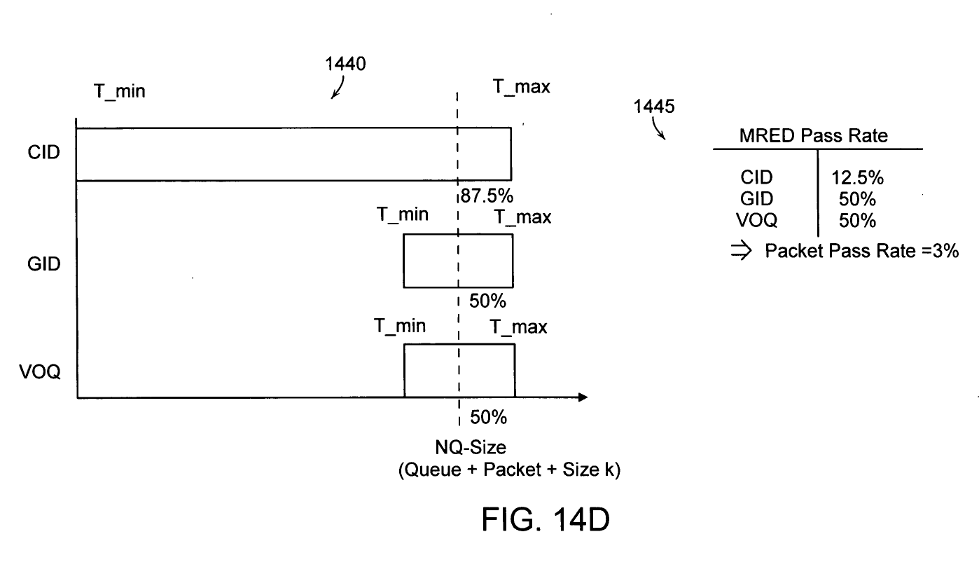

FIGS. 14A-D illustrate a number of different ways in which congestion thresholds can be configured to achieve the aforementioned example design criteria. FIGS. 14A-14D each include a graph set up in a similar manner as in FIG. 13B, except that only one exemplary threshold region (T_min−T_max) is shown among the CID, GID and VOQ thresholds. Here, a test packet results in an NQ_Size with a uniform byte count through all thresholds. In practice, the NQ_Size may be different among the threshold regions because the GID and VOQ queues may also include packets from flows other than that of the CID. Similarly, a VOQ may also include packets from flows other than those of the GID and CID.

FIG. 14A is a graph 1410 that illustrates an “identical” configuration, in which the values for T_min and T_max are the same for the CID, GID and VOQ thresholds. The dashed vertical line 1412 illustrates the byte count of an exemplary NQ_Size that is used by the MRED processes of FIG. 4 and FIG. 12 to determine whether to drop a packet. Here, the NQ_Size includes a packet that is subject to being dropped within this threshold, and the NQ_Size is at 50% of the threshold regions of the CID, GID and VOQ. A table 1415, “MRED Pass Rate,” to the right of the graph 1410, calculates the final pass rate of this packet as 12.5%, which is a product of the pass rates for the CID, GID and VOQ thresholds.

FIG. 14B is a graph 1420 that illustrates an example dynamic threshold configuration according to the invention analogous to the thresholds RM and GX of P1-P3 in FIG. 13B. The minimum threshold T_min is uniform across all hierarchical levels (i.e., red, yellow and green), the maximum threshold T_max is graduated such that the GID threshold range is double the size of the CID threshold range, and the VOQ threshold range is double the size of the GID threshold range. Such a configuration may be effective in guaranteeing passage of packets corresponding to the thresholds (e.g., the green packets under configurations P1-P3 are guaranteed passage). Because T_min is uniform across hierarchical levels in the example embodiment, all packets of a lower priority are dropped when the NQ_Size is above T_min, thus guaranteeing a minimum queue size for passing the highest-priority packets. This queue size is equal to the byte count of each threshold: CID T_max−T_min for each packet flow; GID T_max−T_min for each group; and VOQ T_max−T_min for the entire VOQ.

In addition to guaranteeing the passage of higher-priority packets, the configuration of FIG. 14B may also be effective in controlling interference among higher-priority packets. For example, a flow of a first CID may be causing congestion by sending many high-priority packets. Despite this congestion, this first CID is unlikely to cause a second CID to drop high-priority packets because, when the first CID reaches T_max for the CID queue, it has contributed to no more than half (i.e., 50%) of the GID queue and no more than one quarter (i.e., 25%) of the VOQ. Therefore, because the GID and VOQ queues have capacity beyond the first CID, a second CID may have a higher pass rate than a CID causing congestion. Similarly, because the VOQ threshold maximum is higher than that of each GID, a group of flows causing congestion is less likely to interfere with the passage of flows from another GID.

The table 1425 illustrates a numerical example for a situation in which a flow consumes 50% of a CID queue, 25% of a GID queue, and 12.5% of a VOQ. The pass rate of communications packets in the flow through the traffic management system employing this embodiment can thus be calculated as 50%×75%×87.5%=33%. Moreover, in this example, a given CID cannot consume all bandwidth of its respective GID because the given CID is only half as long as its GID. Similarly, a given GID is only half as long as its VOQ. Thus, each successive hierarchical level can support more than just one lower hierarchical level, ensuring bandwidth for additional lower hierarchical levels. In this way, guaranteed flows are preserved while controlling interference among competing flows.

The embodiment of FIG. 14B is notably found in FIG. 13B in regions GM-GX, the dynamic configurations. Again, in contrast to the “identical” configurations, the dynamic configurations using this graduated region embodiment penalizes flows consuming too much bandwidth (i.e., queue space).

FIG. 14C illustrates another dynamic threshold configuration embodiment, analogous to the thresholds YM of priorities P1 and P2 in FIG. 13B. In this embodiment, T_min among the hierarchy is different at the different hierarchical levels, where the GID threshold begins at the median of the CID, and the VOQ begins at the median of the GID. Additionally, the GID and VOQ T_max are uniform. This configuration is effective in controlling interference among competing flows because the lower CID T_max limits the congestion that each CID can pass to the corresponding GID. Further, the uniform GID and VOQ T_max values may ensure that higher-priority packets may pass without interference by lower-priority packets within the same group or VOQ.

FIG. 14D illustrates yet another dynamic threshold configuration, which is analogous to the thresholds GM of configurations P1 and P2 of FIG. 13B. The CID T_min is much lower than those of the GID and VOQ, which begin at 75% of the CID threshold. T_max is uniform among the thresholds, and the GID and VOQ are identical. This configuration is particularly effective in isolating congestion on individual flows, due to the CID passage rate being relatively lower than those of the GID and VOQ. For example, the sample packet causes an NQ_Size at 87.5% of the CID threshold and has a final pass rate of approximately 3%. For a given queue size within this threshold, a packet is more likely to pass through GID and VOQ thresholds than through the CID. Therefore, packets on congested flows are likely to be dropped before packets within the same group or VOQ, effectively isolating congestion to a particular CID. Further, because T_max is uniform, all packets of a lower priority are more likely to be dropped before higher-priority packets. As a result, this threshold configuration can guarantee passage of higher-priority packets despite congestion.

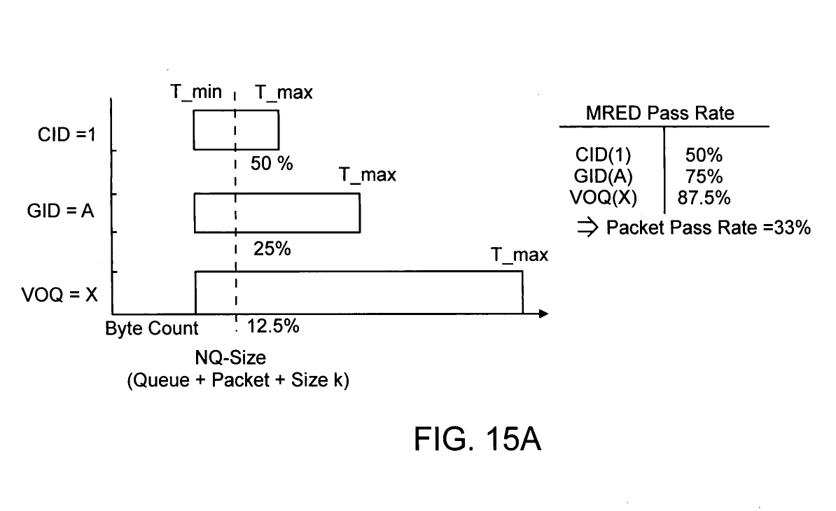

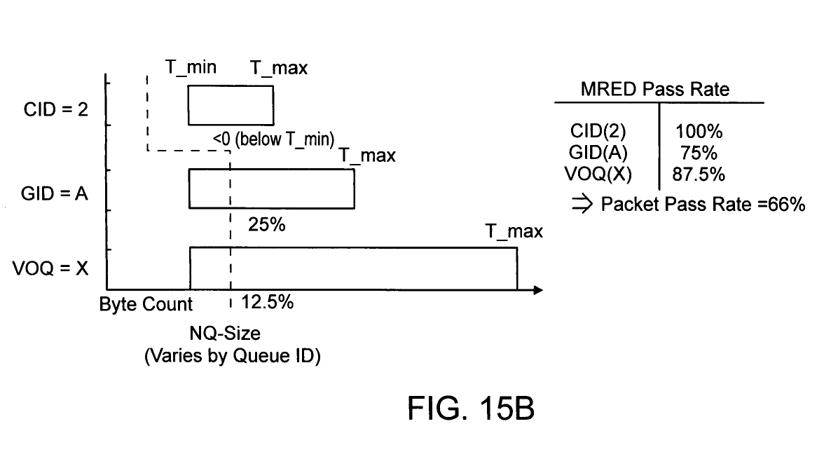

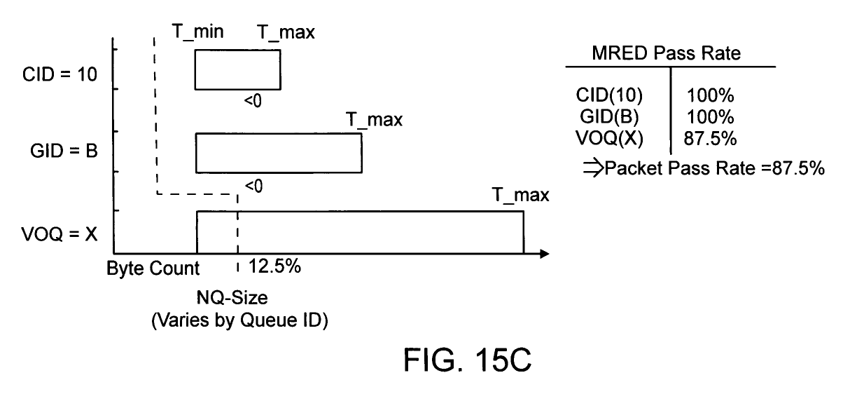

FIGS. 15A-15C illustrate isolation among packet flows of different CID's and GID's as a result of an exemplary congestion threshold configuration. This configuration is analogous to the thresholds of FIG. 14B, as well as RM and GX of P1-P3 in FIG. 13B. Individual flows are distinguished by labels to the left of each chart: CID=1, 2, 10; GID=A, B; and VOQ=X. For the purposes of this example, all packets are the same size (N), and have the same color, which subjects the packets to being randomly dropped within the threshold region.

FIG. 15A illustrates a first packet that arrives at the congestion manager when its respective CID, GID and VOQ all have an equivalent byte count. As a result, the size of the first packet is added to each queue size, resulting in a uniform NQ_size for all thresholds, as shown by the vertical dotted line passing through the thresholds. The first packet has successive pass rates of 50%, 25% and 12.5%, resulting in a final pass rate of approximately 33%.

FIG. 15B illustrates a second packet arriving at the congestion manager after the first packet has been dropped. The second packet originates from a different CID (2), but shares the same GID and VOQ as the first packet. The second packet size is added to the same GID/VOQ queue size, resulting in the same NQ_Size for the GID and VOQ. Thus, the second packet has the same passage rate through the GID and VOQ thresholds as the first packet. However, CID (2) is less congested than CID (1), as shown by the NQ_Size being lower than the CID (2) threshold. Therefore, the second packet is guaranteed to pass through the CID threshold and has a final pass rate of approximately 66%. Because CID (2) is less congested than CID (1), the second packet has twice the pass rate as the first packet. Such a configuration effectively penalizes packet flows causing congestion, while packet flows not causing congestion are less likely to be affected by the congestion. Moreover, in this example, every lower-priority packet is dropped if the NQ_Size reaches the threshold T_min at any of the CID, GID or VOQ. As a result, at least some packets of the given color may be passed regardless of congestion caused by lower-priority packets of the entire VOQ.

FIG. 15C illustrates a third packet arriving at the congestion manager, presuming the first and second packets have been dropped. The third packet shares the same VOQ as the prior packets, but belongs to a different CID (10) and GID (B). The third packet is added to the same VOQ, resulting in the same NQ_Size for the VOQ. Thus, the third packet has the same passage rate through the VOQ threshold as the prior packets. However, both CID (10) and GID (B) are less congested than the prior CID/GID's, as shown by the NQ_Size being lower than the CID (10) and GID (B) thresholds. Therefore, the third packet is guaranteed to pass through these thresholds and has a final pass rate of 87.5%. Because the CID and GID of the third packet are less congested than those of the prior packets, the third packet has the highest pass rate. In addition to isolating packet flows, this configuration minimizes the effect of congestion on a disparate group of packet flows.

The configuration of FIGS. 15A-15C may be applied in a number of ways, and in combination with other configurations such as those of FIGS. 13A and 13B and 14A-14D. Due to the qualities of communications in a specific flow, group or VOQ, it may be possible to further configure thresholds that are specific to a CID, GID or VOQ. For example, all communications of a single CID may have a higher priority than other communications within the same group. To ensure passage, the CID and GID can be configured so that all other traffic in the group is dropped before any traffic of the single CID is dropped. Likewise, a single GID can be configured to have priority over all other traffic to the corresponding VOQ. Such configurations, as well as threshold configurations of FIGS. 13A-13B, 14A-14D and 15A-15C, may be adapted to a range of communications to guarantee passage of a given set of communications while also controlling interference among independent flows of communications competing to pass through a system.

While this invention has been particularly shown and described with references to example embodiments thereof, it will be understood by those skilled in the art that various changes in form and details may be made therein without departing from the scope of the invention encompassed by the appended claims.

What is claimed is:

1. A method of configuring a hierarchical congestion manager, comprising:
setting a first subset of multiple thresholds, associated with each of multiple convergence points in a hierarchical congestion management system in a communications network, to first values that guarantee passage of a subset of communications comporting to pass through the hierarchical congestion management system; and
setting a second subset of multiple thresholds to second values to control interference among independent flows of the communications competing to pass through the system.

2. The method of claim 1 further comprising comparing a queue size in the system to the thresholds to determine whether to pass or drop a newly received communications.

3. The method of claim 1 wherein the subset of communications guaranteed passage are communications conforming to a contract guaranteeing passage.

4. The method of claim 1 wherein the setting a second subset of multiple thresholds minimizes interference among independent flows of the communications competing to pass through the system.

5. The method of claim 1 wherein a lower threshold of an upper range of thresholds is the same at the multiple convergence points.

6. The method of claim 1 further comprising determining whether to pass or drop a communications based on a marker associated with the communications an a probability associated with the marker at each convergence point through the hierarchical congestion management system.

7. The method of claim 1 wherein at least some of the communications are associated with CIDs at a first convergence point, CIDs are associated with GIDs at a second convergence point, and GIDs are associated with VOQs at a third convergence point.

8. The method of claim 1 wherein the multiple thresholds include a maximum threshold value.

9. The method of claim 1 further comprising subjecting a second subset of communications to dropping according to one of: modified random early detection, weighted tail-drop scheme.

10. The method of claim 1 wherein at least some of the multiple thresholds are adapted to isolate a second subset of communications.

11. A system for processing network traffic, comprising:
a first subset of multiple thresholds, associated with each of multiple convergence points in a hierarchical congestion management system in a communications network, configured to guarantee passage of a subset of communications comporting to pass through the hierarchical congestion management system; and
a second subset of multiple thresholds configured to control interference among independent flows of the communications competing to pass through the system.

12. The system of claim 11 further comprising a queue that is compared to the thresholds to determine whether to pass or drop a newly received communications.

13. The system of claim 11 wherein the subset of communications guaranteed passage are communications conforming to a contract guaranteeing passage.

14. The system of claim 11 wherein the second subset of multiple thresholds is configured to minimize interference among independent flows of the communications competing to pass through the system.

15. The system of claim 11 wherein a lower threshold of an upper range of thresholds is the same at the multiple convergence points.

16. The system of claim 11 further comprising determining whether to pass or drop a communications based on a marker associated with the communications an a probability associated with the marker at each convergence point through the hierarchical congestion management system.

17. The system of claim 11 wherein at least some of the communications are associated with CIDs at a first convergence point, CIDs are associated with GIDs at a second convergence point, and GIDs are associated with VOQs at a third convergence point.

18. The system of claim 11 wherein the multiple thresholds include a maximum threshold value.

19. The system of claim 11 wherein a second subset of communications are subject to dropping according to one of: modified random early detection, weighted tail-drop scheme.

20. The system of claim 11 wherein at least some of the multiple thresholds are adapted to isolate a second subset of communications.

21. A system for processing network traffic, comprising:
means for guaranteeing passage of a subset of communications comporting to pass through a hierarchical congestion management system in a communications network; and
means for controlling interference among independent flows of the communications competing to pass through the system.
